(19) United States
(12) Patent Application Publication
(10) Pub. No.: US 2016/0364664 A1
(43) Pub. Date: Dec. 15, 2016

(54) Method and system for high-speed business method switching

(71) Applicants: GRANT PATRICK HENDERSON, NASHVILLE, TN (US); SARAH MICHELLE GRAY, NASHVILLE, TN (US)

(72) Inventors: GRANT PATRICK HENDERSON, NASHVILLE, TN (US); SARAH MICHELLE GRAY, NASHVILLE, TN (US)

(21) Appl. No.: 15/180,178

(22) Filed: Jun. 13, 2016

Related U.S. Application Data
(60) Provisional application No. 62/175,367, filed on Jun. 14, 2015.

(51) Int. Cl. G06Q 10/06; G06Q 40/04

(52) U.S. Cl. CPC G06Q 10/0637; G06Q 40/04; Y10S 707/945

(57) ABSTRACT

Disclosed are various embodiments of systems and methods for high-speed business method switching that increases the likelihood that a transaction will occur between a plurality of participants by extrapolating, evaluating, and executing business methods on a per transaction basis. The present invention relates to the fields of business management, economics, computer science, information science, and software engineering.

### CROSS-REFERENCE TO RELATED APPLICATIONS

Provisional application No. 62/175,367, filed on Jun. 14, 2015.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### CLAIM OF PRIORITY

This patent application claims the benefit of priority, under 35 U.S.C. Section 119(e), to U.S. Provisional Patent Application Ser. No. 62/175,367, entitled “System and methods that evaluate, sort, present, and execute business methods on a per transaction basis”, filed on Jun. 14, 2015 to Henderson, et. al., which is hereby incorporated by reference herein in its entirety.

### TECHNICAL FIELD

The present invention relates to the fields of business management, economics, computer science, information science, software engineering, and generally to a database of records compiled from entities with common links and methods that transform these records.

### BACKGROUND OF THE INVENTION

Before any transaction occurs in any market, each participant must agree upon the terms of trade which may include price, the time frame for completion, whether a product is available for rent instead of purchase, and/or some non-monetary exchange.

Each participant may value terms differently, and if the participants can't agree on the terms of trade, no transaction will occur.

Different business methods (e.g., simple sale, rental, barter, auction, layaway) may require radically different contracts and different business processes. Because of the difficulty and/or expense of switching between methods, many sellers choose a limited number of business methods to simplify contracts, transactions, and processes (e.g., a seller who rents items may be unwilling to sell or barter because the seller lacks the necessary contract or established process).

A buyer may be unwilling or unable to transact using the business method available from a particular seller, effectively leaving value out of the market (e.g., the buyer will only rent, while the seller will not rent). Alternatively, a would-be buyer may turn to illegitimate methods (e.g., piracy) when the seller will not transact using the buyer's preferred method.

Piracy, grey markets, and black markets may be commercially viable to the owners of those commerce systems. For example, in media piracy, systems often utilize ad-supported business methods, thereby rewarding the system owner for enabling theft, even though no money is transferred between buyers and sellers.

By engaging in a limited number of business methods, a seller may miss opportunities to sell their product or to maximize revenue from it.

The one-size-fits-all approach to business methods (in which the seller offers only a limited number of business methods, irrespective of the methods buyers prefer), when implemented on a large scale, results in decreased total revenues to both sellers and systems. In addition, such limitations result in significantly lower sales and poor buyer experiences.

The ad-supported third-party paid business method is straightforward for both sellers and buyers. Sellers do not need to set prices, and buyers consume content without paying. However, many sellers consider the revenue generated through the ad-supported model to be insufficient, while many buyers would prefer simply to pay for the content they consume rather than viewing ads. Moreover, an unlimited access subscription can produce insufficient revenue for sellers, while some individual buyers underpay and are subsidized by other buyers who consume less. In each case, buyers, who have limited or no choice other than to accept the business methods offered by each seller or system, often choose to not participate and go elsewhere.

Such systems artificially limit the amount of money a given buyer may choose to spend on transactions with sellers.

In the cases where an apparent choice of business method is given to a buyer (e.g., an auction plus buy now), the chosen business methods are simply offered in parallel without regard to the preferences of an individual buyer. There is no automatic switching of business methods that takes into consideration the needs of each participant in every transaction. This limitation increases the likelihood of no transaction occurring, as the methods offered by a seller may not be compatible with the method preferred by a buyer.

The preferences of buyers also are not static, as the same buyer may prefer different methods for different transactions. For example, a buyer may for one transaction be willing to watch an ad, but at other times may prefer to purchase a single use of a product, and at still other times may subscribe to recurring delivery.

Low Speed Examples

In a retail environment, a seller advertises a product for sale (e.g., a television set for $1,000) and a buyer offers to buy that product. The buyer may have insufficient funds to purchase immediately, and the seller may then recommend alternative business methods, such as financing (where a third party provides funds to purchase the product from the seller and the buyer agrees to pay the third party) or layaway (where the buyer pays for a product over a period of time with final delivery on completion of all payments). Thus, business methods may be manually switched to a finance method or a layaway method to meet the mutual requirements and/or preferences of the buyer and the seller.

In a retail environment, a seller may advertise a television at $1,000. While price may be the initial focus of a negotiation, other terms may be modified to make the proposed transaction more attractive. For instance, the buyer may respond with an offer to pay $800 in cash, rather than credit. The seller may counter with an offer to allow the buyer to purchase the television for $925 on layaway.

Only the participants know their respective positions. Perhaps the buyer is unwilling to spend more than $900, while the seller is willing to sell the television for $800 in a cash transaction. In this case, the terms of the buyer and seller are mutually acceptable, and both parties will benefit from a successful transaction. However, the transaction here requires successful communication between the buyer and seller. If either the buyer or seller fails to make their terms known (e.g., the seller plays “hardball” and refuses to admit that he is open to a price lower than $950), a desirable transaction will be abandoned instead of completed.

In a retail environment, a seller advertises a product for sale. There is a limited supply (e.g., only one television set) and multiple potential buyers desire the product immediately. In this scenario, the seller can sell to only one of the potential buyers and he must devise a method for choosing between them. To do so, the seller proposes to sell the product to the buyer willing to pay the highest price. The original advertised price becomes a starting point for offers from the interested buyers. This is an example of a marketplace business method that is manually switched to an auction business method to meet the mutual requirements of a group of buyers and the seller. The ability of the seller to switch from a simple sale model to an auction results in a transaction with greater value (e.g., the seller receives $1,100 instead of the $1,000 list price).

Limitations of Existing Commerce Systems

Negotiations regarding terms rarely occur in practice because they are time-consuming and inefficient.

A manual negotiation is highly dependent on the particular characteristics of each buyer and seller. The buyer and/or the seller must be aware that alternative terms (other than the original offer) are possible, and each must be able to effectively communicate their needs and offers to find the best mutually-acceptable business method. Even when both the buyer and seller are able to negotiate, practical limitations often present themselves. For example, both parties must have the authority and ability to actually switch business methods (e.g., an employee negotiating terms for a sale with a potential buyer in a retail environment may not have authority to offer the buyer financing, even if both parties know that such terms would result in a desirable transaction). In addition, the cost of switching between methods may be prohibitive, especially for low-value transactions (e.g., $0.01). There are currently no commerce systems that offer an optimal set of business methods that meet the needs of all participants.

Even when the needs of all participants are compatible and a mutually desirable transaction is possible, the likelihood of a successful transaction diminishes when the participants must manually communicate and negotiate to complete the transaction. Often, the challenges and costs of manually performing those activities lead to abandonment of the transaction by one or more participants, and an opportunity to create value through a mutually beneficial exchange is missed.

What is needed is a solution that performs high speed business method switching to meet the needs of both buyers and sellers and increase the likelihood that a transaction will occur.

### SUMMARY OF THE INVENTION

The present invention teaches a method and system for high-speed business method switching on a per transaction basis, thereby meeting the needs of Buyers, Sellers and Third Parties, increasing the likelihood that a transaction will occur.

The system comprises:

a central database system that stores information about the state of each entity, the relationships between entities, communication between entities and transactions performed between entities;

methods for storing and transforming information that involve entity relationships, entity communication and entity transactions;

computer servers (including but not limited to server farms, and other scalable server technologies) and physical network connections (including but not limited to ethernet, wi-fi, and other electronic data networks) that facilitate electronic communication from the Switching System to any remote terminal (including but not limited to computer, mobile device, tablet, and other input/output devices).

### BRIEF DESCRIPTION OF THE DRAWINGS

FIG. 1 illustrates a computer system architecture, including the Switching System, its servers, databases, methods, a computer network by which communication will occur, and the remote terminal of a Participant.

FIG. 2 illustrates a computerized method for authentication and identification of a Participant.

FIG. 3 illustrates a representation of a set of Options presented to a User for a single use or an unlimited use of a Product paid by a User.

FIG. 4 illustrates a representation of a set of Options presented to a User for a single use of a Product paid by a User or a single use of a Product paid by a Third Party.

FIG. 5 illustrates a representation of a set of Options presented to a User for a single use of a Product paid by a User or a single use of a Product paid by a Third Party.

FIG. 6 illustrates a representation of a set of Options presented to a User after an initial purchase has been made for an upgrade to an unlimited use of a Product paid by a User or to provide a gratuity paid by a User.

FIG. 7 illustrates a representation of a set of Options for playing media that the User is currently permitted to use and to provide a gratuity plus other Options.

FIG. 8 illustrates a representation of a set of Options presented to a User for a single use of a Product paid by a User or a specific use of a Product paid by an Owner or a specific use of a Product according to terms negotiated between Participants.

FIG. 9 illustrates a representation of a set of Options presented to a User for repeat use of a Product or upgrading to unlimited use of a Product by a User.

FIG. 10 illustrates a representation of an Option for a single use of a Product paid by the owner of the Product.

FIG. 11 illustrates a set of database tables.

FIG. 12 illustrates an entity relationship diagram of database tables.

FIG. 13 illustrates a computerized method for presenting Options.

FIG. 14 illustrates a computerized method for executing an Option.

FIG. 15 illustrates a computerized method for executing an optimized Option.

FIG. 16 illustrates a minimalized computerized method for transforming a set of Techniques to a set of Options.

FIG. 17 illustrates a typical computerized method for transforming a set of Techniques to a set of Options.

FIG. 18 illustrates examples of Techniques before a transformation into a set of Options.

FIG. 19 illustrates examples of Options after a transformation from a set of Techniques.

FIG. 20 illustrates examples of Options after a transformation from a set of Techniques.

FIG. 21 illustrates a database entity relationship diagram for the storage of Wallets, Media, Transactions, Contracts, Techniques, and Options.

FIG. 22 illustrates a computerized method for displaying a media preview.

FIG. 23 illustrates a computerized method for displaying Primary Options.

FIG. 24 illustrates a computerized method for ranking Techniques and presenting Options when displaying Primary Options.

FIG. 25 illustrates a computerized method for displaying Other Options.

FIG. 26 illustrates a computerized method for executing an Option.

FIG. 27 illustrates a computerized method for executing an Optimized Option.

FIG. 28 illustrates a computerized method for provisioning media and assigning a set of Techniques to a media item.

FIG. 29 illustrates a computerized method for delivering media.

### DETAILED DESCRIPTION OF THE INVENTION

The present invention teaches a method and system for high-speed business method switching on a per transaction basis, thereby meeting the needs of Buyers, Sellers and Third Parties, and increasing the likelihood that a transaction will occur. The phrase “Switching System” or “System” is used as a simplified reference to this invention.

The Switching System is not, itself, a business method. Rather, the Switching System is a system and processes for automatically switching between all possible business methods on a per-transaction, per-user basis in order to maximize the chances of a successful transaction.

For example, a Seller might be willing to provide content to a Buyer in exchange either for payment from the Buyer or for payment from a Third-Party advertiser (who will in turn advertise to the Buyer). A media Product may generate $0.05 for the Seller if the Buyer pays directly, but only $0.01 if a Third-Party advertiser pays to advertise to the viewer. If the Seller chooses a single business method for all Buyers, the Seller will not generate the maximum possible revenue. Choosing ad-supported as the sole business model means that the Seller only gets $0.01 from some Buyers who would in fact pay $0.05 to enjoy ad-free media; choosing retail as the sole model (e.g., Buyer must pay $0.05 for the media) results in generating no income from some Buyers who are not willing to pay out of pocket but would be willing to watch an ad (thereby generating $0.01 in revenue).

In another example, the Switching System can take into consideration the preferences of the individual Buyers. In addition to letting the Seller switch between multiple business methods, the Switching System also enables input from the individual Buyer. Therefore, while a Seller's preferred business methods may remain constant across two different Buyers, the Switching System may account for the individual Buyer's preferences and therefore present two different Buyers with different Options. For instance, based on information such as the Buyer's past purchasing behavior, the amount of money available to the Buyer, and the Buyer's stated preferences (such as “never show me ad-supported content”), the Switching System may present one Buyer with an ad-supported Option while presenting another only with a paid Option. Such individual or manual dealing would be prohibitively expensive and difficult for most Sellers, especially for low-value transactions. The Switching System offers a practical, effective method for customizing business methods to individual Buyers per transaction.

A block diagram of the Switching System is shown in FIG. 1.

The Switching System 100 comprises:

a database system 103 that stores information about each entity and about the relationships between entities;

computerized methods 102 for storing and manipulating information involving entity relationships;

computer servers 101 (including server farms, distributed computers, and/or other scalable server technologies) and physical network connections 104 (including ethernet, wi-fi, and/or other electronic data networks) that facilitate electronic communication from the Switching System 100 to any remote terminal 105 (including, but not limited to, personal computers, server computers, mobile devices, tablets, and/or other input/output devices).

The computerized methods 102 are executed by one or more data processors and processor memory within the computer servers 101 of the Switching System 100 that manipulate data stored in the database 103 according to the rules of the computerized method.

The computerized methods 102 of the Switching System 100 are accessed and initiated via HyperText Markup Language (HTML), application programming interfaces (API), and/or other network and communications technologies at a Remote Terminal 105 by one or more Participants 106.

Definitions

The following definitions clarify terminology. The definitions may make references to the music and entertainment industries to illustrate practical examples and applications, however, the invention is not intended to be limited to these industries.

Commerce System

A Commerce System is a computerized environment for the sale and/or exchange of Products and/or Value.

The elements of a Commerce System may include, but are not limited to, Products, Participants, Transactions, Contracts, and Techniques.

The term System is used to define both a Commerce System and any computer server system that implements a Commerce System.

Products, Value, and Currency

A Product is any item that may be bought, sold, or in any way transacted upon for its tangible and/or intangible qualities. A Service is a type of Product that often includes intangible qualities such as skills, time, and/or labor. A Media item is a type of Product that often includes intangible qualities such as intellectual property (e.g., a movie or song). Other terms may be used to define specific types of Products.

An Electronic File is one example of a Media item (and therefore a Product) and may include data representing audio, video, 3D video, text, images, and/or any other information.

Value is any benefit(s) either tangible and/or intangible given and/or received as part of, or as a result of, a Transaction. For example, money, time, good will, and/or consumer attention may be given and/or received as part of a Transaction.

Currency is any unit of Value that may be used to describe a Value. For example, Dollars, Yen, Bitcoin, and time are each units of Value, and therefore may be a Currency.

Participants

Participants are individuals and/or entities that participate in some way in the System. Participants include Users and Owners, plus any number of Intermediaries and/or Third Parties.

A User is any individual or entity (or group thereof) who requests, receives, and/or consumes a Product. A User may sometimes be known as a Consumer or a Buyer. For example, an individual who requests and/or receives a video on a website is a User.

A Buyer is often a User, but any Participant may act as a Buyer; for example, Owners, Intermediaries, Third Parties, and/or the System itself may act as a Buyer.

An Owner is any individual or entity (or group thereof) who create and/or own and/or hold legal rights in one or more Products. For instance, a singer-songwriter or a movie studio may be an

Owner. An Owner may sometimes be known as a Seller. The term Owner may also refer to an Intermediary that is involved in a Transaction as the legal Owner's representative.

A Seller is often an Owner, but any Participant may act as a Seller; for example, Users, Intermediaries, Third Parties, and/or the System itself may act as a Seller.

An Intermediary is any individual or entity (or group thereof) that acts on behalf of an Owner or Buyer in regards to a specific Transaction. Intermediaries include, but are not limited to, agents, managers, publishers, distributors, rights holders, clearinghouses, rights organizations, associations, or any entity claiming to represent an Owner or Buyer or to otherwise hold management rights in a Product.

A Third Party is any individual or entity (or group thereof) that is neither a User, nor an Owner, nor an Intermediary, on a particular Transaction yet participates in the Transaction. Often, a Third Party provides Value to facilitate delivery of a Product, usually (but not necessarily) in return for some benefit. For example, an advertiser who pays the Owner of a video each time a User plays the video in exchange for the opportunity to advertise to the User is a Third Party. Third Parties include, but are not limited to, advertisers, sponsors, exhibitors, charitable donors, or any individual/entity providing some kind of Value in a Transaction. Such benefits may include, but are not limited to, branding, public awareness, and/or sales opportunities.

The Commerce System may act as a User, Owner, Intermediary, and/or Third Party.

Transactions & Contracts

In many Commerce Systems, especially in the music and entertainment industries, various terms may be used to define different Contracts and Transactions for the same Product. For example, “streams”, “rentals”, “sales”, “purchases”, and “licenses” may be used to refer to different Contracts and Transactions for the same song or video.

A Transaction is any transfer of one or more Products and/or Value between two Participants. A Transaction usually involves a Buyer and a Seller, where the Buyer typically provides payment to the Seller, and the Seller provides one or more Products and/or associated Value to the Buyer.

A Contract typically defines one or more terms and conditions of a Transaction between two Participants, usually a Buyer and a Seller. Each Contract may define a price, a number of uses, an expiry date, and/or any other agreed upon right or restriction for use of the Product.

The Transaction refers to the actual transfer of Products and/or Value, while the Contract generally refers to the legally enforceable terms and conditions relating to that transfer.

Laws and/or other government acts (e.g., copyright) may grant, take away, and/or limit the rights and/or obligations of any Participant, irrespective of the existence or terms of a Contract.

Techniques

A Technique is a specific process used in a Commerce System to accomplish the exchange of Products and/or Value. A Technique may be commonly described as a “business method,” “business process,” and/or “business model.” The term Technique is used herein to avoid confusion with “method” or “process,” which are used herein to describe the operation of a computer system.

For the purposes of this invention, a Technique may be both (1) a process; and/or (2) a set of data that may be used to describe and execute a process in a computer system.

Every Technique involves at least two Participants. Some Techniques may involve more than two Participants acting as Buyers and/or Sellers in any combination or quantity. For example, a group buying Technique may involve a single Seller and multiple Buyers.

Some Techniques may be structured to appear as a Product-for-Product exchange (e.g., barter Technique), instead of as a Product-for-Value exchange (e.g., a retail Technique). A Product-for-Product exchange should be viewed as two separate Product-for-Value Transactions that are executed simultaneously, where the Value of one Transaction offsets the Value of the other Transaction.

All complex Techniques can be broken down into a set of discrete Contracts and Transactions, each of which involves exactly two Participants and a Product-for-Value exchange. The set of all Transactions and Contracts may be executed simultaneously in a single Data Transaction, either in parallel, or in sequence when the Transactions and Contracts are interdependent.

In many Techniques, the Participant who provides Value in exchange for the Product is also the Participant who receives the Product; however, there are some Techniques in which one Participant provides Value in exchange for a Product that is received by another Participant (e.g., purchasing a Product as a gift for someone else). They may be the same party (e.g., in an auction Technique the User is also the Buyer) or they may be entirely different parties (e.g., in an ad-supported Technique the User uses the Product and an advertiser pays for it as the Buyer).

Payments in Techniques

In every Technique one or more Participants will directly or indirectly provide Value in exchange for each Product. Therefore, each Technique may be classified by answering the question, “who provides payment for each transaction?” The payer will either be the User, the Owner (where an Intermediary may be considered an Owner), a Third Party (where the Third Party may include the System itself), or any combination thereof.

In a User-Paid Technique, the financial payment for the provision of the Product comes from the end User (or Buyer) who receives the benefit of those goods and/or services. Examples of User-Paid Techniques include marketplaces, subscriptions, and auctions.

In an Owner-Paid Technique, the financial costs of delivering the Product are paid for by the Owner (either entirely or partially, such as through reduced prices or rebates), who may also be known as the Seller. This Technique is usually employed strategically, such as for promotional purposes or to drive sales of a different product (e.g., as a loss leader).

In a Third-Party-Paid Technique, the financial costs of delivering the Product are paid for by a Third Party who is neither the User nor the Owner. An example of a Third-Party-Paid Technique is the ad-supported Technique. Using this Technique, the User does not pay for the Products purchased because the Owner receives payment from a Third Party who in return is allowed to advertise to the User.

Other Terms

A Transaction is intended to define a Financial Transaction, where a Financial Transaction tracks the transfer of Value and/or Products between Accounts.

A Data Transaction tracks a set of changes to any data in a computer system. Financial Transactions, when implemented in computers, typically occur within Data Transactions to ensure that Value and/or Products are accurately transferred across multiple Accounts without error. Unless otherwise specified, the term Transaction herein refers to a Financial Transaction.

Techniques represent all possible ways that a Seller is willing to engage in business relating to a specific Product or set of Products. When the Buyer initiates engagement (such as by viewing a Preview of a Product), the System transforms all of the possible Techniques into a set of available Options, which are further sorted and presented to the Buyer according to their resulting ranks for acceptance and then execution. For example, a Seller may designate a dozen possible Techniques, including simple retail, auction, and/or ad-supported; the Seller may further specify that the ad-supported Technique is not available on Saturdays. Therefore, when a Buyer engages with the relevant Product on a Saturday, the possible Techniques are transformed into a set of Options excluding all ad-supported Options; if the Buyer engages with the Product on Sunday, the Buyer may receive both retail and ad-supported Options.

An Option is a specific instance of a Technique available for execution at some point in time. For example, a Seller may be willing to engage in an ad-supported Technique and may have five advertisers each willing to pay in full for advertising on a specific product. In that case, the Technique is ad-supported and there are five Options. In a different case, each of the five advertisers may only be willing to pay in full for advertising under certain circumstances (e.g., only on a particular day of the week, only for Users with a balance greater than $1.00, or only during prime viewing hours), with the result that at a given time there may be fewer available Options than there are possible Techniques.

Attributes include any additional information that can be used to describe an object. Attributes may be included in any record.

The term Intersection is used to define its common meaning as a logical AND operation, and it is also used to define more complex combinations of logical AND and/or OR operations (e.g., A and/or B, and/or [A and/or C], and/or [A and/or D], etc. which may be interpreted in many ways).

Preview means a display of a Product (or of information about the Product) that is designed to encourage the User to make a purchase of the Product. The precise content of the Preview varies according to the nature of the related Product and the individual Seller's choices. For example, an image with a description could be the Preview for a physical product (e.g., a CD); a trailer could be a Preview for a feature film; or the first 10% of text could be a Preview for a book or article.

Delivery means a provision of a product to the User after a purchase. The method of provision varies according to the nature of the Product. For example, a feature film may be delivered digitally (in the case of an Electronic File) or physically (in the case of a DVD).

Authentication and Identification

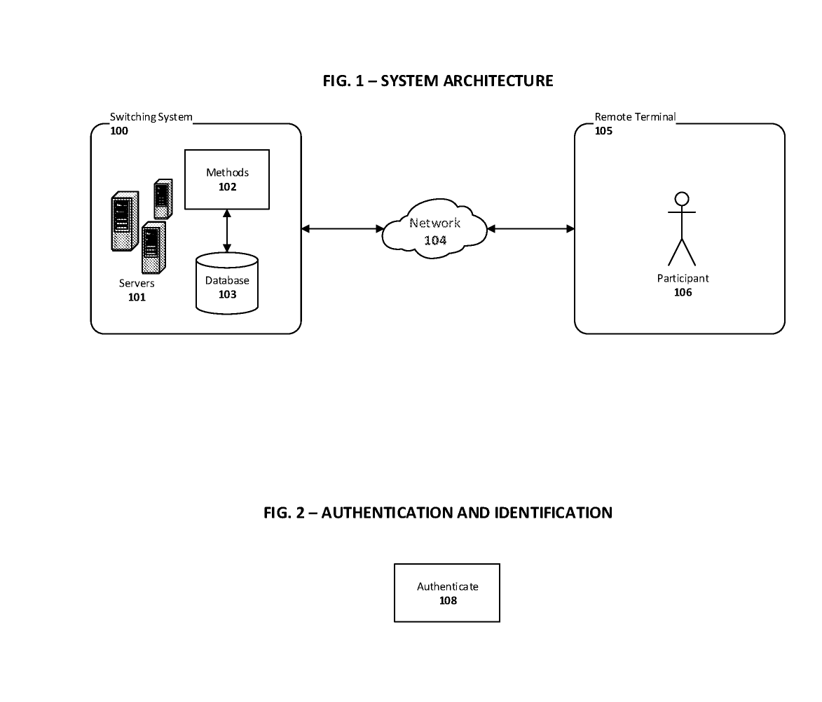

A method for authentication and identification is shown in FIG. 2.

A Participant 106 authenticates 108 with the Switching System 100 by providing a unique identifier (e.g., email, username, account number, and/or other unique identifiers) and authorization key (e.g., password, PIN, and/or other private keys), and optionally agrees to abide by any required terms and conditions regarding use of the Switching System.

Genneric Embodiments

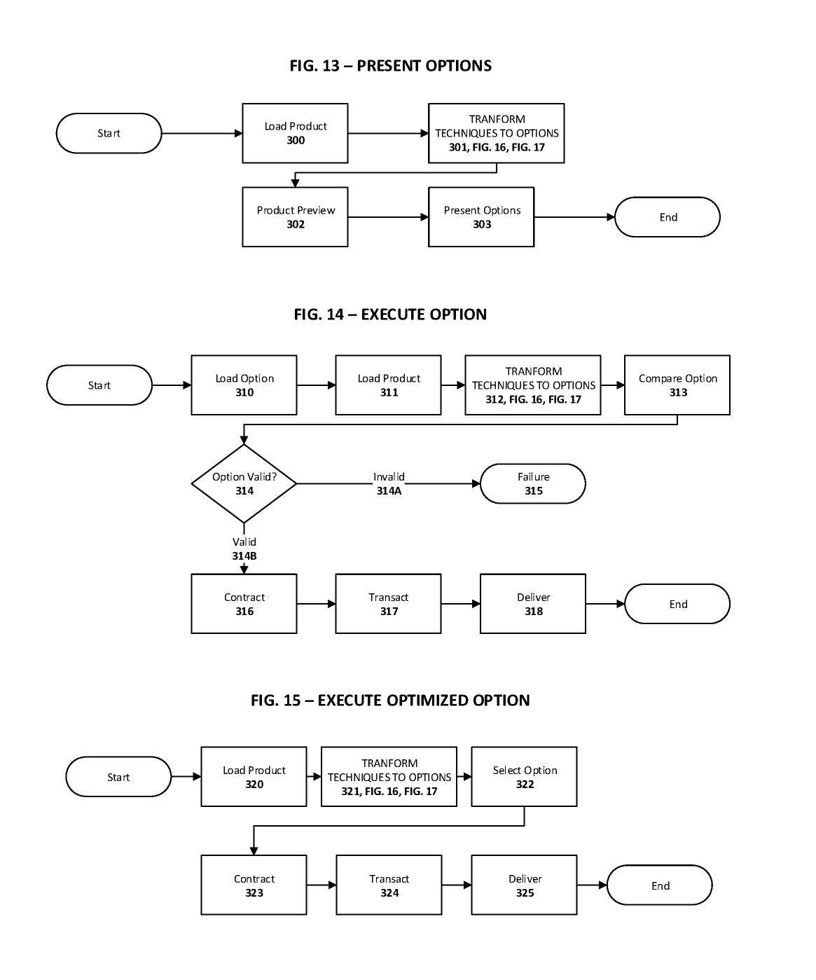

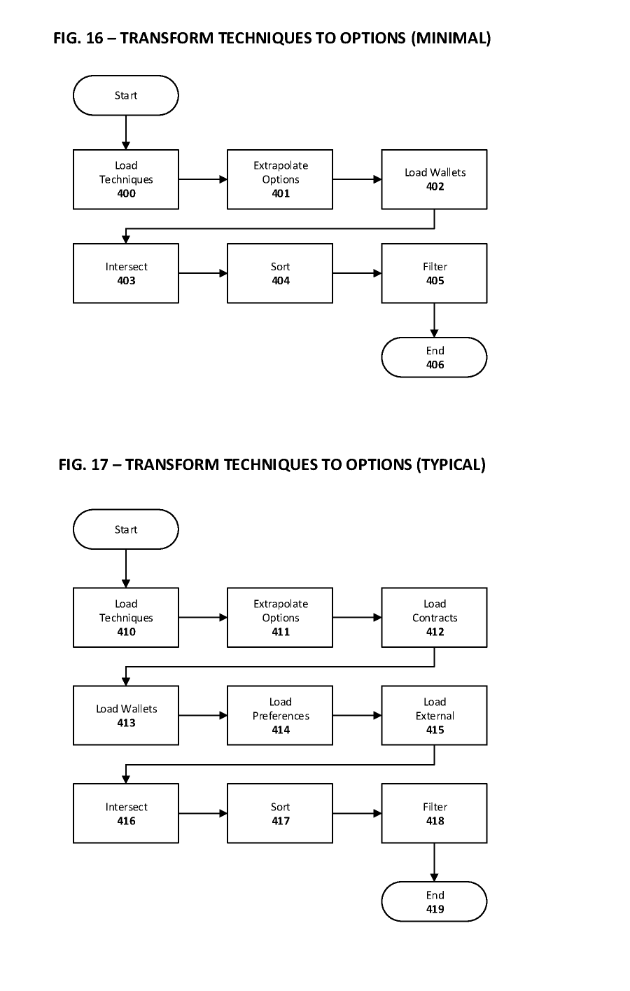

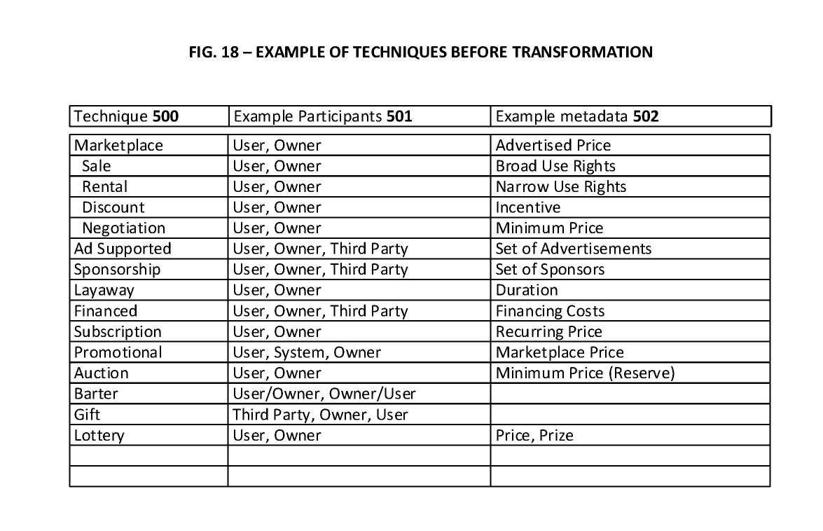

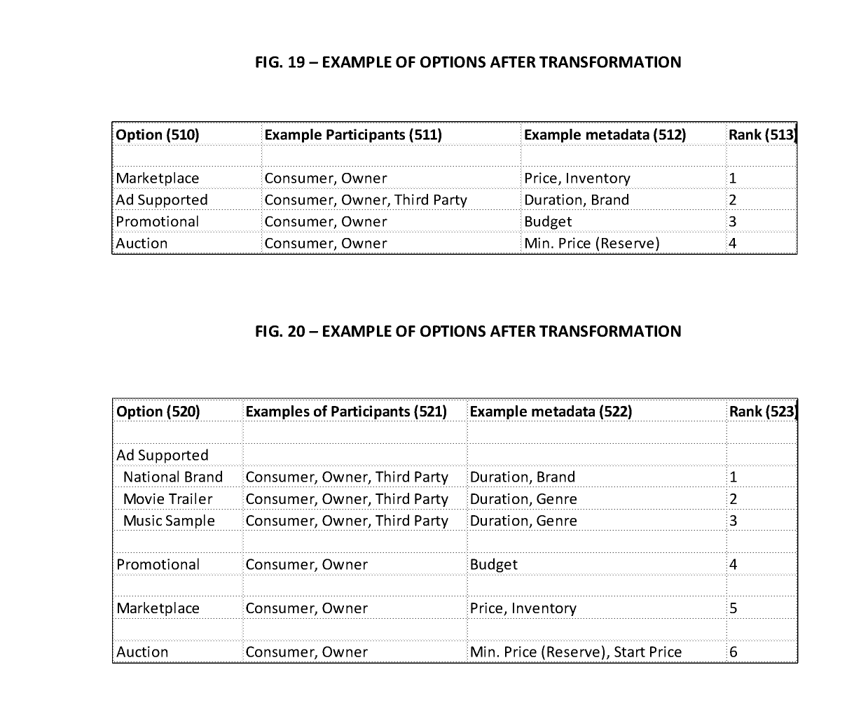

In an embodiment of the present invention, possible Techniques are transformed to available Options that are evaluated, sorted, presented, and executed as illustrated in FIG. 13, FIG. 14, FIG. 15, FIG. 16, and FIG. 17. Examples of a set of possible Techniques before a transformation into available Options is illustrated in FIG. 18 and a set of available Options after a transformation are illustrated in FIG. 19 and FIG. 20.

Database Tables and Entity Relationship Diagram

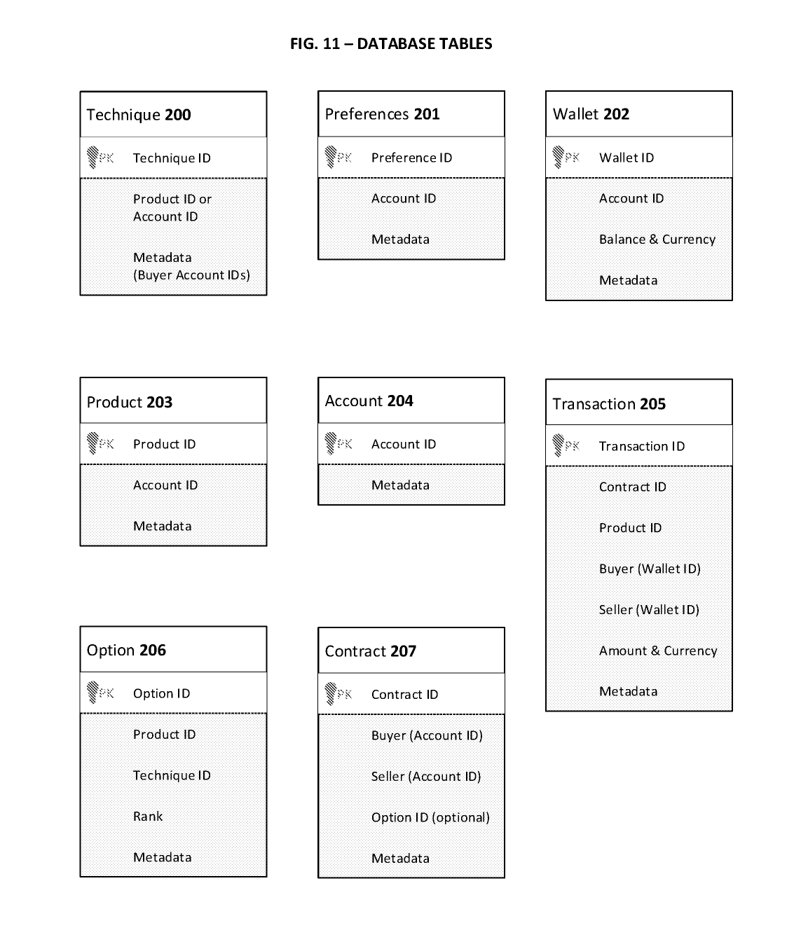

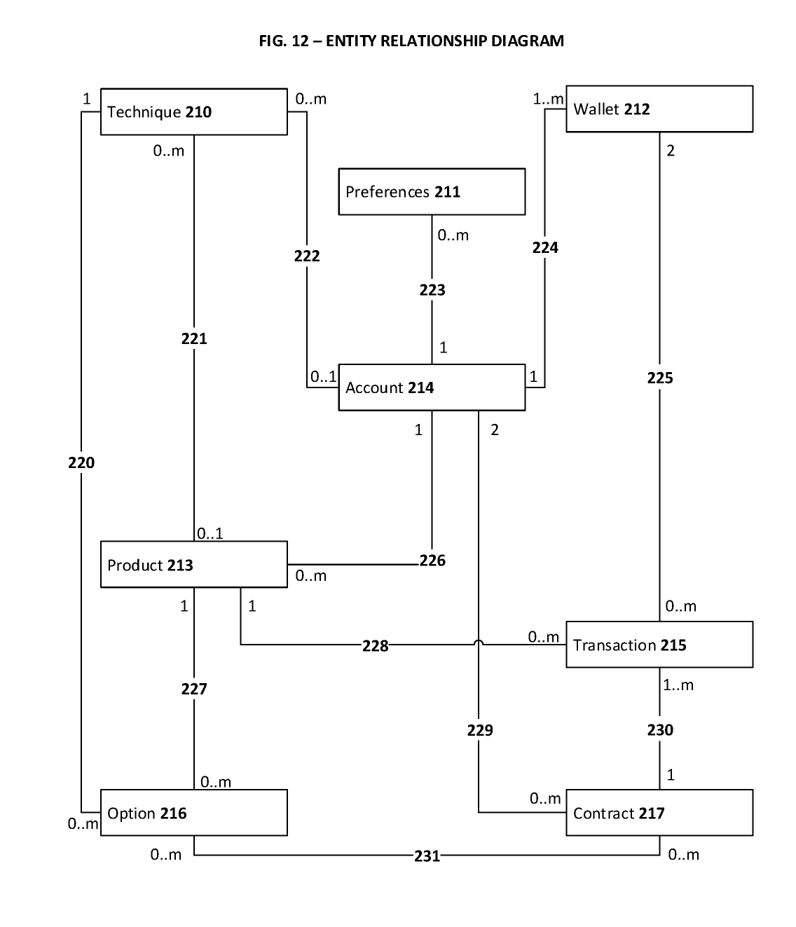

FIG. 11 illustrates one possible set of database tables and FIG. 12 illustrates an entity relationship diagram of the same tables that are used to store states and relationships in the Switching Systems.

An Account 204 & 214 record includes an Account ID primary key field, and optionally Metadata fields that describe other Attributes. An Account 204 & 214 record is used to identify and store the state of each Participant in the Switching System.

A Preferences 201 & 211 record includes a Preference ID primary key field, an Account ID reference field to an Account 204 & 214 record, and optionally Metadata fields that describe other Attributes. A Preferences 201 & 211 record is used to store the state of any preferences for each Participant in the Switching System.

A Wallet 202 & 212 record includes a Wallet ID primary key field, an Account ID reference field to an Account record, a Balance field (as a Value), a Currency field, and optionally Metadata fields that describe other Attributes. A Wallet 202 & 212 record is used to store Value for each Participant in the Switching System. An Account 204 & 214 record may have many associated Wallet 202 & 212 records, even for the same Currency.

Value may be added to a Wallet 202 & 212 record (to adjust the Wallet's Balance field) from an external source such as transfer from a credit card, bank account, check, or any other method of payment. This addition of Value may occur manually at the request of the Wallet owner or automatically when certain criteria are met (e.g., a minimum balance triggers a top-up payment). Value may also be added from an internal source, such as through a transfer or payment from another Participant.

A Technique 200 & 210 record includes a Method ID primary key field, either an Account ID reference field to an Account 204 & 214 record or a Product ID reference field to a Product 203 & 213 record, and optionally Metadata fields that describe other Attributes. A Technique 200 & 210 record is used to store the state of a Technique used by a Participant in the Switching System.

Each Technique 200 & 210 record contains Metadata fields that describe and control the execution of each Technique. The Metadata fields are intended to be flexible to cover all Techniques. For example, an ad-supported Technique 200 & 210 record may include references to a list of Account IDs or Wallet IDs, each one representing a Third Party Participant in the Technique. Each Account ID or Wallet ID may be used during an extrapolation of Technique 200 & 210 records into a set of Option 206 & 216 records by extrapolating Account ID or Wallet ID metadata fields of each Technique 200 & 210 record. Other examples of Metadata fields include, but are not limited to, a Technique classification (e.g., ad-supported, marketplace), contract requirements, contract rights, contract restrictions, availability (e.g., from and to dates), and pricing information for a specific Product 203 & 213 record. The Technique 200 & 210 record may also include a priority and other Metadata fields to evaluate and sort the Technique 200 & 210 records for processing.

By intentionally leaving the scope of the Technique Metadata fields open, the present invention may incorporate new Techniques into the Switching System. For example, crowdfunding is a relatively new Technique; though more complex than most ordinary transactions, a crowdfunding Technique can be nonetheless be structured as a set of Contracts and Transactions, each involving exactly two Participants. Distilling Techniques into discrete Contracts and Transactions allows this invention to accommodate any present or future Technique, without regard to the Technique's complexity or number of Participants. For example, in a Technique where A buys from B, and B buys from C, and C buys from D and E, all metadata may be included into a single Technique 200 & 210 record, and that metadata may be extrapolated into a set of Option 206 & 216 records, and ultimately a set of Contract 207 & 217 records and Transaction 205 & 215 records.

A Product 203 & 213 record includes a Product ID primary key field, an Account ID reference field to an Account 204 & 214 record, and optionally Metadata fields that describe other Attributes. A Product 203 & 213 record is used to store the state of a Product in the Switching System. In the case of Media Products, the Media itself may be stored as metadata (e.g., in a movie product, the media file itself is as an Attribute).

A Transaction 205 & 215 record includes a Transaction ID primary key field, a Contract ID reference field to a Contract 207 & 217 record, a Product ID reference field to a Product 203 & 213 record, a Buyer Wallet ID reference field to a Wallet 202 & 212 record, a Seller Wallet ID reference field to a Wallet 202 & 212 record, an Amount field (as a Value), a Currency field, and optionally Metadata fields that describe other Attributes. A Transaction 205 & 215 record is used to store the state of a Transaction.

A Contract 207 & 217 record includes a Contract ID primary key field, a Buyer Account ID reference field to an Account 204 & 214 record, a Seller Account ID reference field to an Account 204 & 214record, an optional Option ID reference field to an Option 206 & 216 record, and optionally Metadata fields that describe other Attributes of the Contract. A Contract record is used to store the state of a Contract.

An Option 206 & 216 record includes an Option ID primary key field, a Product ID reference field to a Product 203 & 213 record, a Technique ID reference field to a Technique 200 & 210 record, a Rank field, and optionally Metadata fields that describe other Attributes.

Each Account 204 & 214 record is associated with zero or more Preferences 201 & 211 records, and each Preferences 201 & 211 record is associated with exactly one Account 204 & 214 record 223.

Each Account 204 & 214 record is associated with one or more Wallet 202 & 212 records, and each Wallet 202 & 212 record is associated with exactly one Account 204 & 214 record 224.

Each Product 203 & 213 record is associated with exactly one Account 204 & 214 record, and each Account 204 & 214 record is associated with zero or more Product 203 & 213 records 226.

Each Technique 200 & 210 record is associated with an Account 204 & 214 record and/or a Product 203 & 213 record, and each Account 204 & 214 record and each Product 203 & 213 record is associated with zero or more Technique 200 & 210 records 221 & 222. If a Technique 200 & 210 record is associated with a Product 203 & 213 record but not an Account 204 & 214 record, the Account 204 & 214 record may be inferred via the associated Product 203 & 213 record, as each Product 203 & 213 record is associated with exactly one Account 204 & 214 record 226.

Each Transaction 205 & 215 record is associated with exactly two Wallet 202 & 212 records (one for the Buyer and one for the Seller in a Transaction), and each Wallet 202 & 212 record is associated with zero or more Transaction 205 & 215 records 225.

Each Transaction 205 & 215 record is associated with exactly one Product 203 & 213 record, and each Product 203 & 213 record is associated with zero or more Transaction 205 & 215 records 228.

Each Option 206 & 216 record is associated with exactly one Product 203 & 213 record, and each Product 203 & 213 record is associated with zero or more Option 206 & 216 records 227.

Each Option 206 & 216 record is associated with exactly one Technique 200 & 210 record, and each Technique 200 & 210 record is associated with zero or more Option 206 & 216 records 220.

Each Option 206 & 216 record may be stored persistently or temporarily within the System. Persistence is recommended where an audit trail is required, but is not essential as the Metadata fields of the Option 206 & 216 record will be copied into the final Contract 207 & 217 record (i.e., the Contract 207 & 217 record provides the persistence).

Each Contract 207 & 217 record is associated with exactly two Account 204 & 214 records (one for the Buyer and one for the Seller), and each Account 204 & 214 record is associated with zero or more Contract 207 & 217 records 229.

Each Contract 207 & 217 record is associated with one or more Transaction 205 & 215 records, and each Transaction 205 & 215 record is associated with exactly one Contract 207 & 217 record 230.

Each Contract 207 & 217 record is associated with zero or more Option 206 & 216 records, and each Option 206 & 216 record is associated with zero or more Contract 207 & 217 records 231. During the EXECUTE OPTION FIG. 14 computerized method, any relevant metadata may be copied from the Option 206 & 216 record or Technique 200 & 210 record into the final Contract 207 & 217 record, allowing the implementer the discretion to delete the Option 206 & 216 record.

Another embodiment of this invention may combine Contract 207 & 217 records and Transaction 205 & 215 records into a single database record. For the purposes of illustrating the financial and legal aspects of Contract 207 & 217 records and Transaction 205 & 215 records, each table is illustrated separately 215 & 217.

Another embodiment of this invention may incorporate Account 204 & 214 records and Wallet 202 & 212 records into a single database record, especially where a single Currency is used. However, it is preferred to keep Account 204 & 214 records and Wallet 202 & 212 records separate for the purposes of supporting multiple Currencies.

Another embodiment of this invention may incorporate Account 204 & 214 records and Preferences 201 & 211 records into a single database record.

Furthermore, Account 204 & 214 and/or Preferences 201 & 211 records may themselves encapsulate metadata of preferred Techniques, however, this has not been illustrated as self-referencing records can be difficult to visualize. For example, the Account and/or Preferences records are implemented as Technique records.

In another embodiment of this invention, an Account 204 & 214 record may represent a set of Account 204 & 214 records (e.g., a User Account owned by a family with multiple member Accounts) but is illustrated herein as representing a single Account 204 & 214 record. This hierarchical Account 204 & 214 record structure may be implemented with any depth.

In another embodiment of this invention, a Product 203 & 213 record may represent a set of Product 203 & 213 records (e.g., an album of songs, a bundle of computer parts, or a three-course meal) but is illustrated herein as representing a single Product 203 & 213 record. This hierarchical Product 203 & 213 record structure may be implemented with any depth.

In another embodiment of this invention, a Transaction 205 & 215 record may represent a set of Transaction 205 & 215 records (e.g., line items on an invoice may each be separate Transactions) but is illustrated herein as representing a single Transaction 205 & 215 record. This hierarchical Transaction 205 & 215 record structure may be implemented with any depth.

In another embodiment of this invention, a Contract 207 & 217 record may represent a set of Contract 207 & 217 records (e.g., different terms and conditions for each line item on an invoice may each have separate Contracts—such as a rental and a purchase) but is illustrated herein as representing a single Contract 207 & 217 record. This hierarchical Contract 207 & 217 record structure may be implemented with any depth.

Present Options

FIG. 13 illustrates a computerized method for presenting Options to a User.

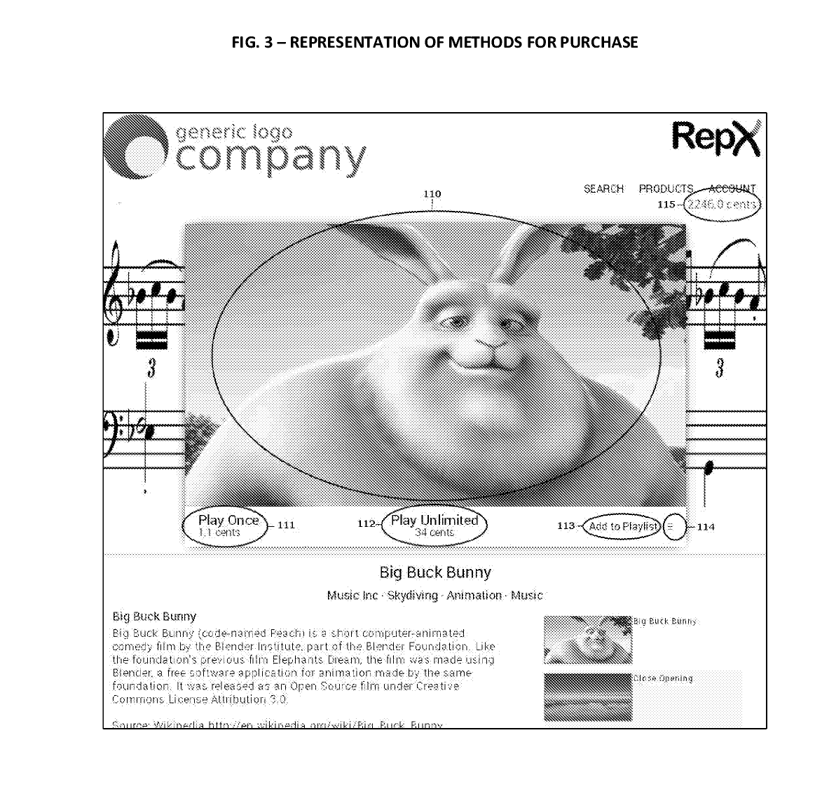

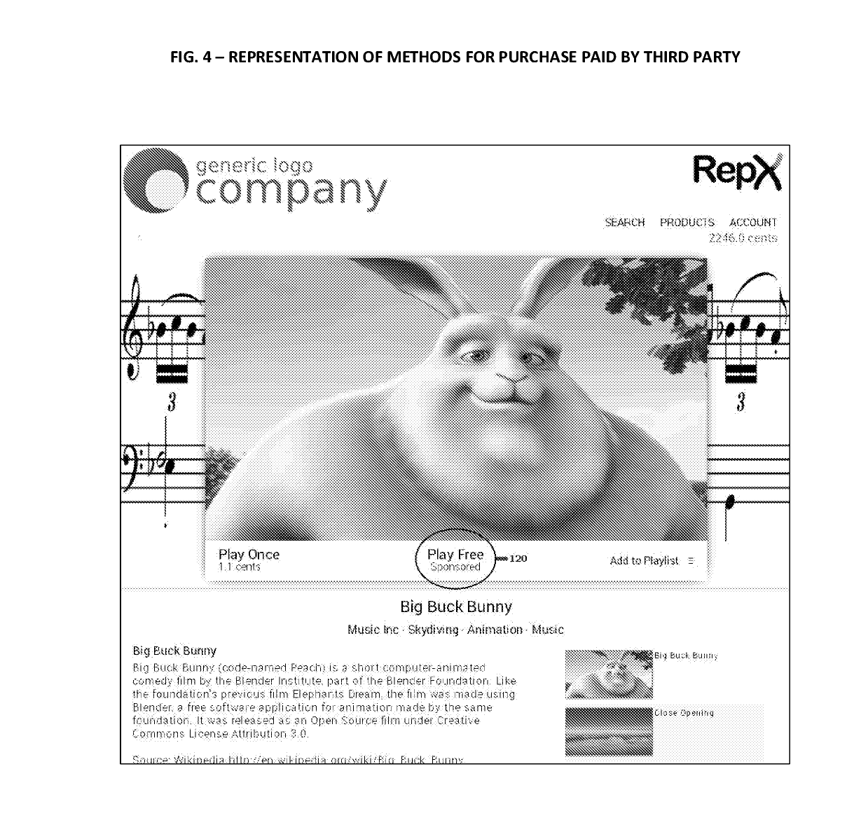

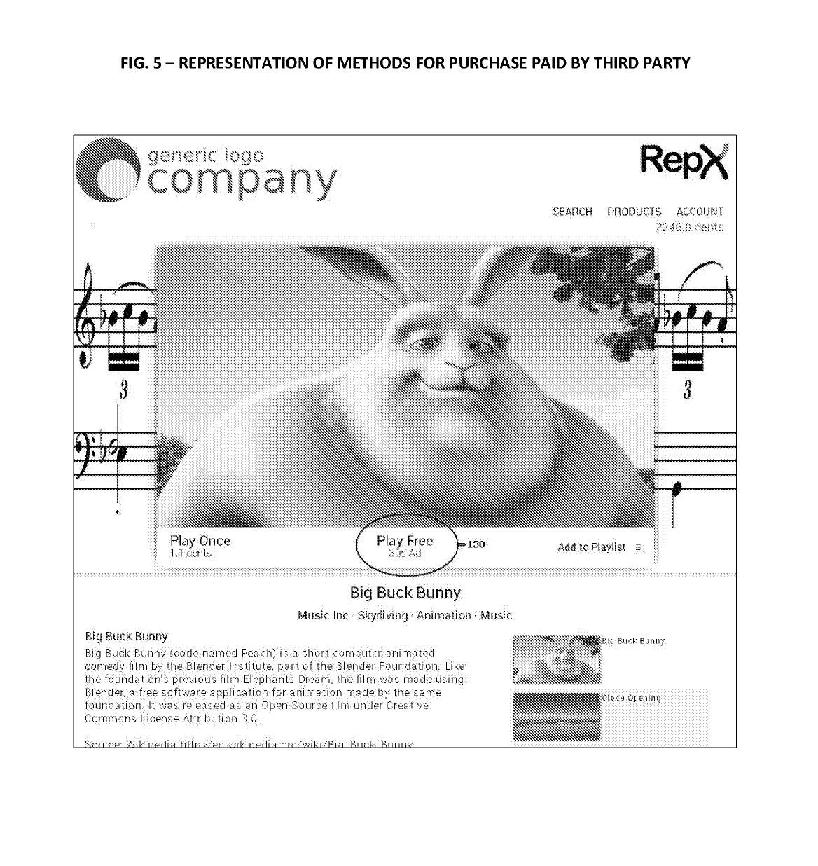

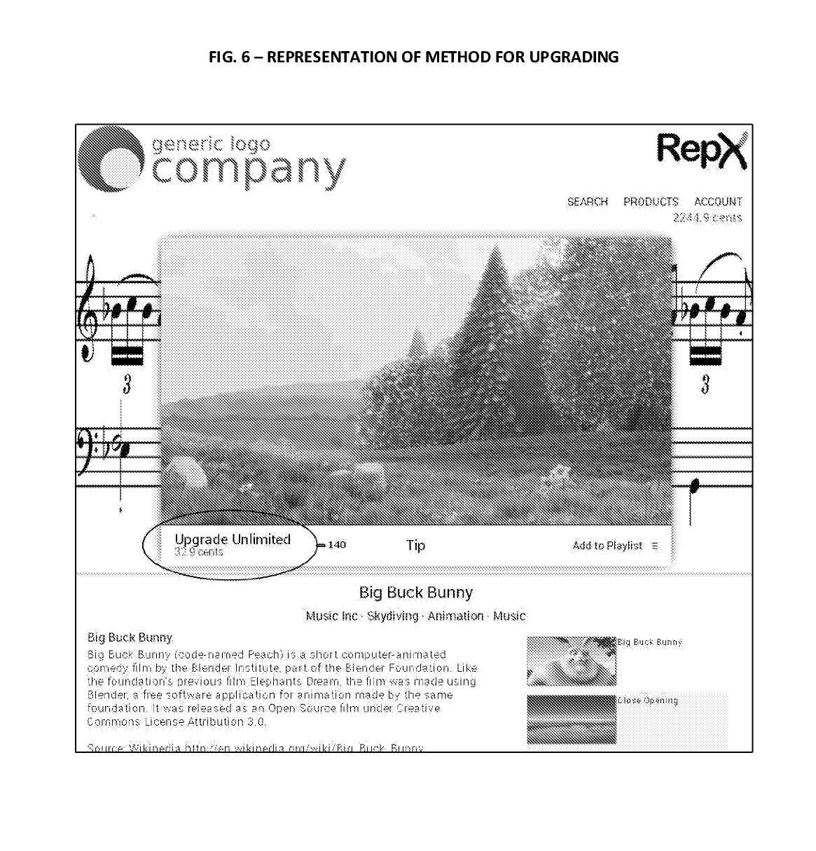

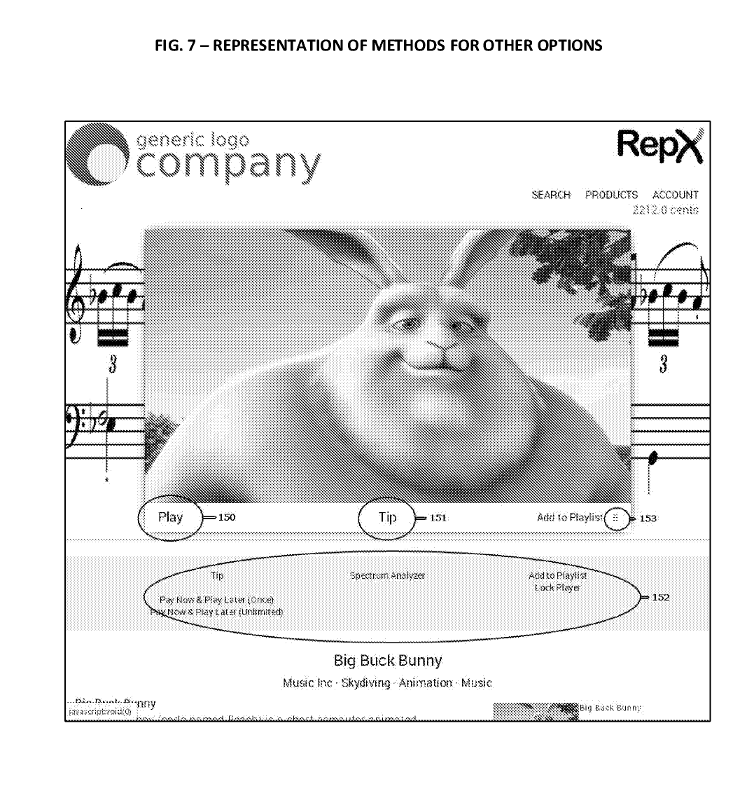

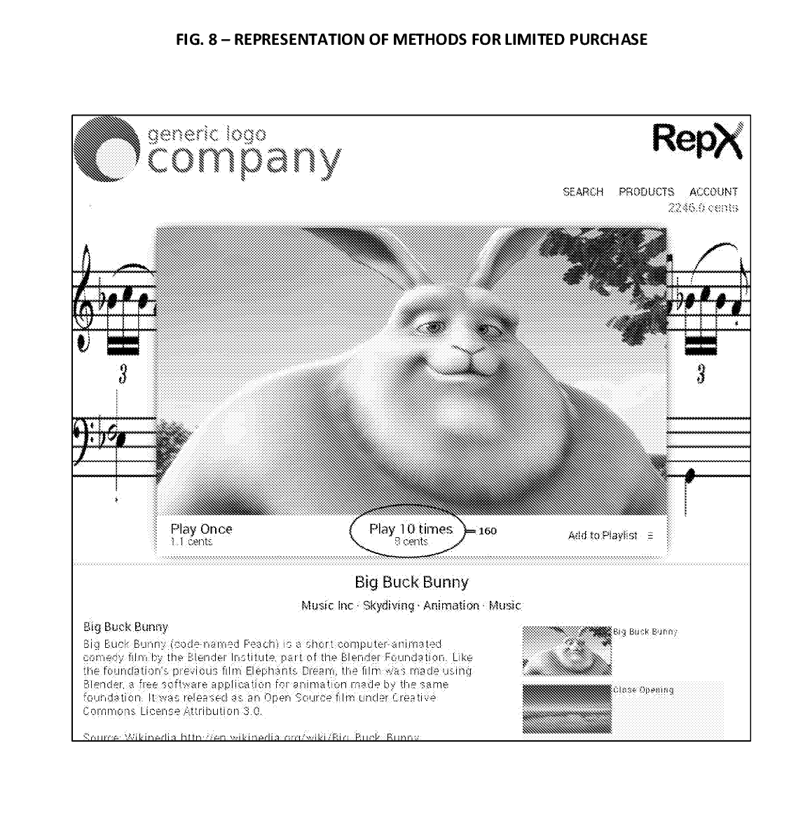

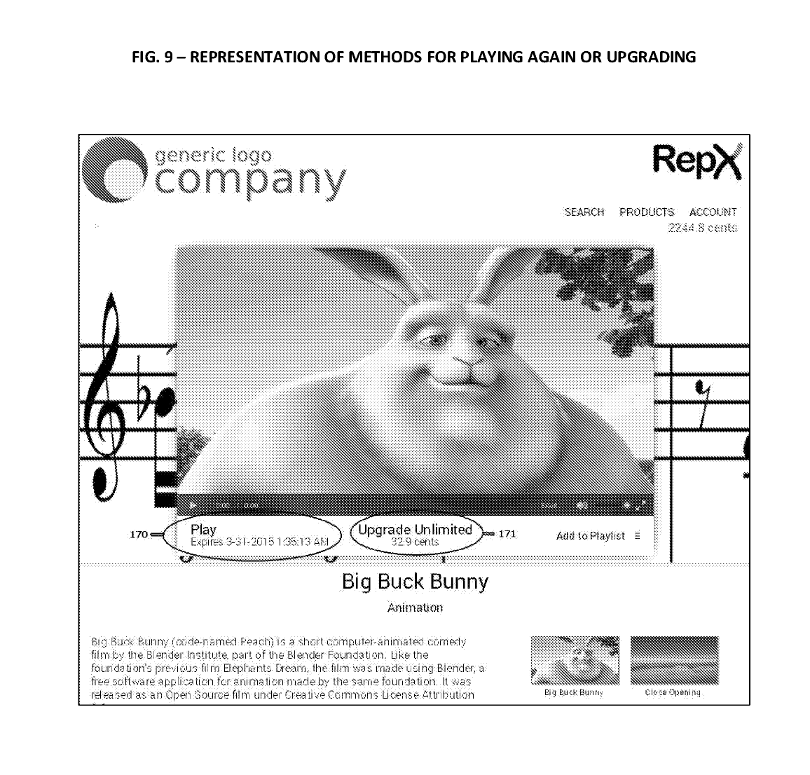

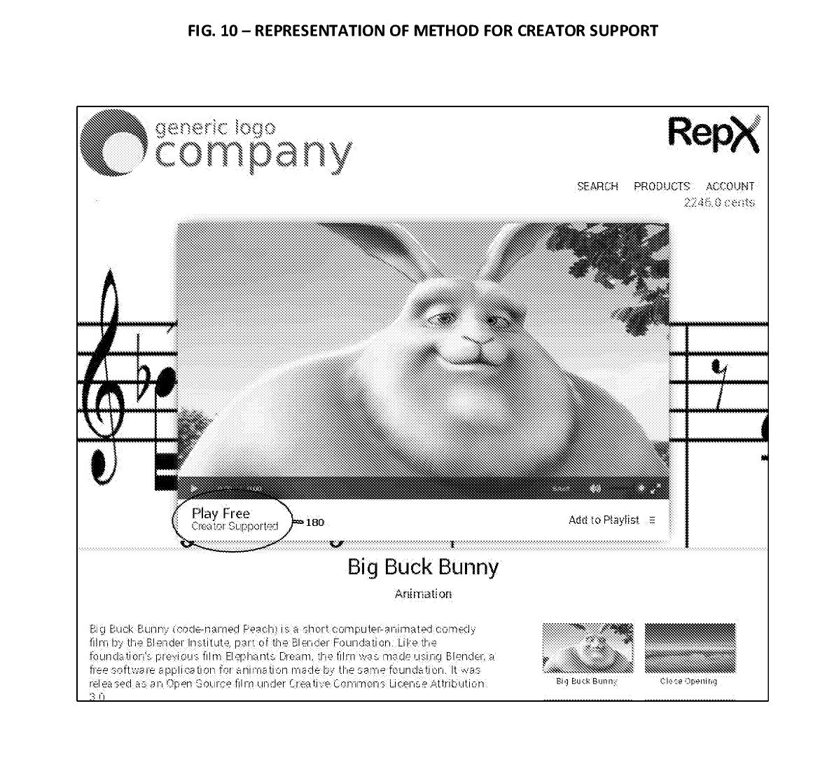

FIG. 3, FIG. 4, FIG. 5, FIG. 6, FIG. 7, FIG. 8, FIG. 9 & FIG. 10 collectively illustrate a practical application of sending Options to a User. These are examples of possible applications, and one of ordinary skill in the art will easily see how other applications are possible. Other implementations include, but are not limited to, application programming interfaces, physical switches, or other interfaces.

The User initiates the PRESENT OPTIONS FIG. 13 computerized method by choosing to Preview a Product through a User Interface, API, or so forth.

The processor loads 300 the Product 203 & 213 record into computer memory.

The processor executes 301 a TRANSFORM TECHNIQUES TO OPTIONS FIG. 16 & FIG. 17 computerized method and receives a set of Option 206 & 216 records. Different embodiments of the present invention may utilize different TRANSFORM TECHNIQUES TO OPTIONS methods. For example, two possible embodiments are illustrated FIG. 16 & FIG. 17.

The processor sends 302 a Product Preview to the User as illustrated in FIG. 3 110.

The processor presents 303 to the User the Option 206 & 216 records returned from a TRANSFORM TECHNIQUES TO OPTIONS computerized method in the order specified by their respective Rank. Any number of Option 206 & 216 records between one and the count of all Option records in the set of Option 206 & 216 records may be sent as a uniquely structured document (e.g., HTML, WML, etc.) or via an application programming interface (e.g., XML, JSON, TCIP/IP over WCF, CORBA, etc.). In the event that no Option 206 & 216 records are returned, the User may be presented with an error (not illustrated).

The Option 206 & 216 records may be separated into subsets of Primary Option 206 & 216 records and Other Option 206 & 216 records for presentation to the User, where Primary Options are displayed more prominently, as illustrated in FIGS. 7 150 & 151, and Other Options are displayed less prominently, as illustrated in FIG. 7 152.

Execute Option

FIG. 14 illustrates a computerized method for executing an Option.

Due to the dynamic nature of the Switching System, an Option 206 & 216 record that is available when presented to the User may not be available at the time the User actually selects it. For example, an Option is valid only until 10:00 pm on a certain date and the Option is presented to the User at 9:58 pm on that date; if the User selects the Option at 9:59 pm it will be valid, but if the User selects the Option at 10:01 pm, it will be invalid.

A User initiates the method by requesting an Option that was presented during the PRESENT OPTIONS computerized method. For example, FIG. 3 & FIG. 13.

The processor loads 310 the requested Option 206 & 216 record into computer memory.

The processor loads 311 the Product 203 & 213 record associated with the Option 206 & 216 record into computer memory.

The processor executes 312 a TRANSFORM TECHNIQUES TO OPTIONS FIG. 16 & FIG. 17 computerized method and receives a set of Option 206 & 216 records. Different embodiments of the present invention may utilize different TRANSFORM TECHNIQUES TO OPTIONS methods. For example, two possible embodiments are illustrated FIG. 16 and FIG. 17.

The processor compares 313 the Option requested by the User with the set of Option 206 & 216 records to determine 314 the validity of the selected Option 206 & 216 record. If the requested Option 206 & 216 record exists in the set of Option 206 & 216 records, the requested Option 206 & 216 record is valid 314B. If the requested Option 206 & 216 record does not exist in the set of Option 206 & 216 records, the requested Option is invalid 314A.

If the requested Option is invalid 314A, the computerized method terminates and notifies 315 the User of the failure.

If the requested Option is valid 314B, the processor creates 316 one or more Contract 207 & 217 records that contain the references and Metadata fields defined by the Option 206 & 216 record, and the processor creates 317 one or more Transaction 205 & 215 records that contain references and Metadata fields defined by the Option 206 & 216 record. All records are permanently stored in the database in a single Data Transaction, and the Product defined by the Product 203 & 213 record is delivered 318 to the User.

Execute Optimized Option

The EXECUTE OPTIMIZED OPTION FIG. 15 computerized method combines the PRESENT OPTIONS FIG. 13 computerized method and EXECUTE OPTION FIG. 14 computerized method, but instead of sending multiple Options to the User for selection, the Switching System automatically selects and executes a single Option on behalf of the User.

The User initiates the method by choosing to Preview a Product and choosing an EXECUTE OPTIMIZED OPTION computerized method. For example, a media implementation of the present invention FIG. 7 150 may initiate this method with a simple Play or Play Best button, although any number of presentations (e.g. “Stream Best” or “Optimize” or “Best Deal”) could be used. The User may set the “Execute Optimized Option” method as a default Preference (for example, when set as the default Preference, the User may see only a simple “Play” Option, which when selected will perform the EXECUTE OPTIMIZED OPTION computerized method), or may select the “Execute Optimized Option” method individually per Product and/or Transaction (e.g., the User is presented with Primary Options along with a “Play Best” Option, which will select and execute one of the presented Options on the User's behalf). Displaying the available Options and a “Play Best” Option (which, when selected, triggers the EXECUTE OPTIMIZED OPTION method) allows the User to see the available Options without the burden of having to compare and choose between the Options (e.g., the User sees that the Options are “Play Once for $0.05” or “Play Free with Ad,” and therefore has all the information, but can select “Play Best” to avoid the work of actually choosing between them).

The processor loads 320 the Product 203 & 213 record into computer memory.

The processor executes 321 the TRANSFORM TECHNIQUES TO OPTIONS FIG. 16 & FIG. 17 computerized method and receives a set of Option 206 & 216 records. Different embodiments of the present invention may utilize different TRANSFORM TECHNIQUES TO OPTIONS methods. For example, two possible embodiments are illustrated FIG. 16 and FIG. 17.

The processor selects 322 the Option 206 & 216 record that is highest-ranked after the TRANSFORM TECHNIQUES TO OPTIONS computerized method is executed.

Although the highest-ranked Option 206 & 216 record is selected in this embodiment, other embodiments may select an Option 206 & 216 record according to different criteria, such as (without limitation) an Option 206 & 216 record chosen at random, an Option 206 & 216 record in accord with specific Preferences, or an Option 206 & 216 record that meets some other criteria. For example, a User may set in their Preferences that if a Product costs $0.50 or less, they always want to pay for it instead of receiving an ad, but if a Product costs more than $0.50, they always want to receive an ad instead of paying for it. In that case, the Switching System may select and execute an Option in accord with that User's defined Preferences.

The processor creates 323 one or more Contracts 207 & 217 records that contain the references and Metadata fields defined by the Option 206 & 216 record, and creates 324 one or more Transaction 205 & 215 records that contain references and Metadata fields defined by the Option 206 & 216 record. All records are permanently stored in the database in a single Data Transaction, and the Product defined by the Product 203 & 213 record is delivered 325 to the User.

Transform Technique to Options (Minimal)

In one embodiment of the present invention, a simple transformation may be performed to convert a set of Technique 200 & 210 records to a set of Option 206 & 216 records. This computerized method is illustrated in FIG. 16.

For a given Product 203 & 213 record and/or Account 204 & 214 record, the processor loads 400 the referenced Technique 200 & 210 records from the database into computer memory.

If a Product 203 & 213 record does not reference any Technique 200 & 210 records, the Account 204 & 214 record may be inferred from the Product 203 & 213 record and the processor loads 400 the referenced Technique 200 & 210 records of the Account 204 & 214 record from the database into computer memory.

When no Technique 200 & 210 record exists for a specified Account or Product, the processor may create a single default Technique 200 & 210 record in computer memory. It is recommended that the default Technique 200 & 210 record use a marketplace Technique. However, any default Technique is possible. For example, marketplace Techniques typically advertise a price set by the Seller. However, if no price is set, a “Make an Offer” feature may be used to invite potential Buyers to suggest a price.

The processor extrapolates 401 the set of possible Technique 200 & 210 records into a set of available Option 206 & 216 records. At a minimum, the extrapolation will copy each Technique 200 & 210 record into an Option 206 & 216 record. For example, a sale Technique 200 & 210 record may be extrapolated into a sale Option 206 & 216 record and a rental Technique 200 & 210 record may be extrapolated into a rental Option 206 & 216 record.

In a more complex embodiment of the present invention, a processor may extrapolate 401 a Technique 200 & 210 record into multiple Option 206 & 216 records based on Metadata contained in the Technique 200 & 210 record. For example, an ad-supported Technique 200 & 210 record may have multiple advertisers described in its metadata as illustrated in FIG. 18 502, and the processor may extrapolate each advertiser into its own Option 206 & 216 record as illustrated in FIG. 20 520. A marketplace Technique 200 & 210 record with sale and rental metadata may be extrapolated into a sale Option 206 & 216 record and/or a rental Option 206 & 216 record.

The intent of TECHNIQUE TO OPTION extrapolation is to give the implementer maximum flexibility as to how each Technique 200 & 210 record is extrapolated into each Option 206 & 216 record. By using a default one-to-one mapping, or simple one-to-many mapping, no undue experimentation is required by one with ordinary skill in the art.

The Technique 200 & 210 records loaded in step 400 may be used to identify Participants that are involved in each Technique. Each Participant is identified by an Account 204 & 214 record, and that Account 204 & 214 record may be used to identify a specific Wallet 202 & 212 record for use by each Technique. The processor loads 402 these Wallet 202 & 212 records into computer memory and the processor tests 402 the Wallet Balances for validity. Examples of Wallet 202 & 212 records loaded include, but are not limited to, zero or more User Wallets, Owner Wallets, Third Party Wallets, and/or Intermediary Wallets.

A Balance is considered valid if a Transaction that uses a specific Option 206 & 216 record would result in the Balance remaining at or above zero after the Transaction has completed. A Balance is considered invalid if a Transaction using a specific Technique 200 & 210 record would result in the Balance falling below zero after the Transaction has completed, and if the execution of any other method to replenish that Balance is unsuccessful (e.g., an automatic balance increase through a top up payment may be triggered, thereby turning a potentially invalid Balance into a valid Balance).

If a Balance is tested and found to be invalid, that Option 206 & 216 record may be removed from the set of Option 206 & 216 records. However, an implementer may choose to retain invalid Option 206 & 216 records and ultimately present an error to the User, or to weight each invalid Balance lower than valid Balances to decrease their likelihood of being presented after sorting. An implementer may choose such a course of action for various reasons (e.g., presenting invalid Options may prompt a User to fix their Account).

The processor intersects 403 the set of Option 206 & 216 records to eliminate unsuitable Options 206 & 216 record from the set of Option 206 & 216 records. This intersection may be implemented as an intersection of Option 206 & 216 records and valid Wallet 202 & 212 records found for each Option 206 & 216 record, but the Switching System may define criteria that may include any conceivable feature that the System may use to limit Option 206 & 216 records. For example, the System may prevent ad-supported Options at certain times of day, or the System may prevent auction Techniques if a Wallet Balance falls below a specific value (e.g., $10 minimum).

The processor sorts 404 the set of Option 206 & 216 records. The method of sorting may be chosen by one with ordinary skill in the art without undue experimentation. For example, it is logical that Option 206 & 216 records that reference valid Wallet 202 & 212 records would be ranked above Option 206 & 216 records that reference invalid Wallet 202 & 212 records.

The processor filters 405 the set of Option 206 & 216 records to eliminate unsuitable Option 206 & 216 records from the set of Option 206 & 216 records. Filters may include, but are not limited to, criteria such as a daily limit for a particular Option 206 & 216 record, or complex comparisons within the set of Option 206 & 216 records that are possible only after sorting. For example, a condition may exist that some Option 206 & 216 records must always be ranked below some other Option 206 & 216 records in the set of Option 206 & 216 records, and only if that other Option 206 & 216 record exists. Similarly, some Option 206 & 216 records may be removed as they are not allowed to co-exist with other Option 206 & 216 records.

The processor returns 406 the filtered set of Option 206 & 216 records to the method that requested this transformation of TECHNIQUES TO OPTIONS and the process ends 406.

In other embodiments of the present invention, the steps illustrated in FIG. 16 may be changed, added to, and/or entirely removed by one skilled in the art. For example, loading and testing the User Wallet Balance may be performed before any Technique 200 & 210 records are loaded, or filtering and/or sorting may be performed multiple times.

Transform Techniques to Options (Typical)

In one embodiment of the present invention, a transformation may be performed to convert a set of Technique 200 & 210 records to a set of Option 206 & 216 records using any and/or all available information. A typical transformation may utilize information sourced from, but not limited to, past Contracts, Account Preferences, external sources, and information found internally within the System and/or external to the System to help perform a transformation. This computerized method is illustrated in FIG. 17.

For a given Product 203 & 213 record and/or Account 204 & 214 record, the processor loads 410 the referenced Technique 200 & 210 records from the database into computer memory.

If a Product 203 & 213 record has no referenced Technique 200 & 210 records, the Account 204 & 214 record may be loaded 410 into computer memory and used to infer a Technique 200 & 210 record from the Product 203 & 213 record via the Product's Account ID; then the processor loads 410 associated Technique 200 & 210 records that reference the Account 204 & 214 record from the database into computer memory.

When no Technique 200 & 210 record exists for a specified Account 204 & 214 record and/or Product 203 & 213 record, the processor may create a single default Technique 200 & 210 record in computer memory. It is recommended that the default Technique 200 & 210 record use a marketplace Technique; however, any Technique may be designated as a default. Marketplace Techniques typically advertise a price set by the Seller; however, if no price is set, a “Make an Offer” feature may be used to invite potential Buyers to suggest a price.

The processor extrapolates 411 the set of Technique 200 & 210 records into a set of Option 206 & 216 records. At a minimum, the extrapolation will copy each Technique 200 & 210 record into a unique Option 206 & 216 record. For example, a sale Technique 200 & 210 record may be extrapolated into a sale Option 206 & 216 record and a rental Technique 200 & 210 record may be extrapolated into a rental Option 206 & 216 record.

In a more complex embodiment of the present invention, the processor may extrapolate 411 a Technique 200 & 210 record into multiple Option 206 & 216 records based on the metadata fields contained in the Technique 200 & 210 record. For example, a rental Technique 200 & 210 record may have metadata fields for a daily and monthly price, and the processor may extrapolate each into its own Option 206 & 216 record, yielding a daily Option 206 & 216 record and a monthly Option 206 & 216 record. A marketplace Technique 200 & 210 record may be extrapolated into a sale Option 206 & 216 record and rental Option 206 & 216 record.

The intent of TECHNIQUE TO OPTION extrapolation is to give the implementer maximum flexibility as to how each Technique 200 & 210 record is extrapolated into each Option 206 & 216 record. By using a default one-to-one mapping, or simple one-to-many mapping, no undue experimentation is required by one with ordinary skill in the art.

The processor loads 412 any past Contract 207 & 217 records that reference both the selected Product 203 & 213 record and the current User Account 204 & 214 record from the database into computer memory. Past Contract 207 & 217 records may be used to assess existing rights or obligations for use of the Product by that specific User. For example, if the User already has a single-use license for a Product, an unlimited-use Option 206 & 216 record may be modified to an “Upgrade to Unlimited” Option 206 & 216 record as illustrated in FIG. 9 171, or an unlimited-use Option 206 & 216 record may be modified to a “Play Again” Option 206 & 216 record as illustrated in FIG. 7 150 & FIG. 9 170.

The Technique 200 & 210 records loaded 410 may be used to identify the Participants involved in each Technique. Each Participant is identified by an Account 204 & 214 record, and that Account 204 & 214 record may be used to identify a specific Wallet 202 & 212 record for use by each Technique. The processor loads 413 these Wallet 202 & 212 records into computer memory and the processor tests the Wallet 202 & 212 record Balances for validity. Examples of Wallet 202 & 212 records loaded include, but are not limited to, zero or more User Wallets, Owner Wallets, Third Party Wallets, or Intermediary Wallets.

A Balance is considered valid if a Transaction using a specific Option 206 & 216 record would result in the Balance remaining at or above zero after the Transaction has completed. A Balance is considered invalid if a Transaction using a specific Technique 200 & 210 record would result in the Balance falling below zero after the Transaction has completed, and if the execution of any other method to replenish that Balance is unsuccessful.

If a Balance is tested and found to be invalid, that Option 206 & 216 record may be removed from the set of Option 206 & 216 records. However, an implementer may choose to retain invalid Option 206 & 216 records and ultimately present an error to the User, or to weight each invalid Balance lower than valid Balances to decrease their likelihood of being presented after sorting. An implementer may choose such a course of action for various reasons (e.g., presenting invalid Options may prompt a User to fix their Account by adding money).

The processor loads 414 all Preference 201 & 211 records of each Account 204 & 214 record associated with the set of Option 206 & 216 records from the database into computer memory. Preference 201 & 211 records of all involved Participants may be used to directly alter the Option 206 & 216 records by adding, modifying, or removing Option 206 & 216 records. For example, the User Preferences may indicate that the User never wants to see an ad-supported Technique, so the processor removes all ad-supported Techniques from the set of Options; or Third Party Preferences may indicate that they never want to pay to display an ad to a User with a Wallet Balance of less than $1.00, so the processor removes the Third Party Option from the set of Options.

The processor loads 415 external metadata from any/all available data sources into computer memory. The Switching System itself may be treated as an external source of metadata for past or present information (e.g., current Account Balance, past Transaction, past and current Contracts), and/or metadata from other sources may be loaded (e.g., a credit information provider, government records, partner or third party databases, social media, etc.). This external metadata may be used in conjunction with the Participants' preferences to alter the Option 206 & 216 records (e.g., a Third Party Advertiser may refuse to pay to show ads to a User with fewer than a specified number of connections on an external social network; an Owner may only offer financing options to a User with a specified minimum credit score).

The processor intersects 416 the set of Option 206 & 216 records to eliminate unsuitable Option 206 & 216 records from the set of Option 206 & 216 records. This intersection may be implemented as an intersection of Option 206 & 216 records, and/or Option 206 & 216 records and Wallet 202 & 212 records found for each Option 206 & 216 record, and/or Option 206 & 216 records and Contract 207 & 217 records, and/or Options 206 & 216 records and Preference 201 & 211 records, and/or Option 206 & 216 records and External Metadata, and so forth. Other criteria may be used to limit and/or expand the set of Option 206 & 216 records. For example, the System itself may prevent ad-supported Options at certain times of day, or the System may prevent auction Techniques if a Wallet Balance falls below a specific value (e.g., $10 minimum).

The processor sorts 417 the set of Option 206 & 216 records. The method of sorting may be chosen by one with ordinary skill in the art without undue experimentation. For example, it is logical that Option 206 & 216 records that reference valid Wallet 202 & 212 records would be ranked above Option 206 & 216 records with invalid Wallet 202 & 212 records.

The processor filters 418 the set of Option 206 & 216 records to eliminate unsuitable Option 206 & 216 records from the set of Option 206 & 216 records. Filters may include, but are not limited to, other criteria such as a daily limit for a particular Option, or complex comparisons within the set of Option 206 & 216 records that are possible only after sorting. For example, a condition may exist that some Option 206 & 216 record may only be available if a specified other Option 206 & 216 record is available, and the first Option 206 & 216 record must always be ranked below that other Option 206 & 216 record in the set of Option 206 & 216 records. Similarly, some Option 206 & 216 records may be removed because they are not allowed to co-exist with other Option 206 & 216 records.

The set of Option 206 & 216 records is returned 419 to the computerized method that requested this transformation of TECHNIQUES TO OPTIONS.

In other embodiments of the present invention, the steps illustrated in FIG. 17 may be changed, added to, and/or entirely removed by one skilled in the art. For example, loading and testing the User Wallet Balance may be performed before any Technique 200 & 210 records are loaded, or filtering and/or sorting may be performed multiple times, or external sources of metadata may be loaded before any Technique 200 & 210 records are loaded.

Example of Techniques Before Transformation

FIG. 18 illustrates examples of Technique 200 & 210 records before transformation to a set of Option 206 & 216 records. Each Technique 500 may be stored in a Technique 200 & 210 record together with Participant 501 Metadata, and other Metadata 502.

The Participants 501 represent two or more Participants; it is possible to have multiple Participants of the same type (e.g. Buyers). For example, the Participants in a Group Buying Technique (not illustrated) could include a single Seller and any number of Buyers.

Example of Options After Transformation

FIG. 19 & FIG. 20 illustrate examples of Option 206 & 216 records after transformation from Technique 200 & 210 records. Each Option 510 & 520 may be stored in an Option 206 & 216 record together with Participant 511 & 521 metadata, other metadata 512 & 522, and a Rank 513 & 523.

The Participants 511 & 521 represent two or more Participants; it is possible to have multiple Participants of the same type (e.g. Buyers). For example, the Participants in a Group Buying Technique (not illustrated) could include a single Seller and any number of Buyers.

FIG. 19 illustrates a typical one-to-one transformation of TECHNIQUES TO OPTIONS (e.g. 4 Techniques mapped to 4 Options). FIG. 20 illustrates a typical one-to-many transformation of TECHNIQUES TO OPTIONS (e.g. 4 Technique 200 & 210 records mapped to 6 Option 206 & 216 records), where an ad-supported Technique with a set of advertisements is extrapolated into multiple Option 206 & 216 records. This method can be used for all Metadata fields. For example, a single marketplace Technique record with sale and rental prices could be extrapolated into discrete a sale Option record, and a rental Option record for 7 days.

For simplicity, the examples in FIG. 19 and FIG. 20 have omitted a Technique column, however, it is assumed that each Option 206 & 216 record will have a Technique reference as described in Technique 200 & 210 record.

Embodiments with Specific Steps and Applies to Media Delivery

In another embodiment, the present invention may be adapted by changing the evaluation, sorting, and/or execution of business methods into a specific set of steps. By causing a processor to execute steps in a defined sequence, the embodiment effectively iterates each Technique 200 & 210 record to create a set of Option 206 & 216 records. Therefore, the transformation of Technique 200 & 210 records to Option 206 & 216 records is implicitly extrapolated by the steps in the computerized method.

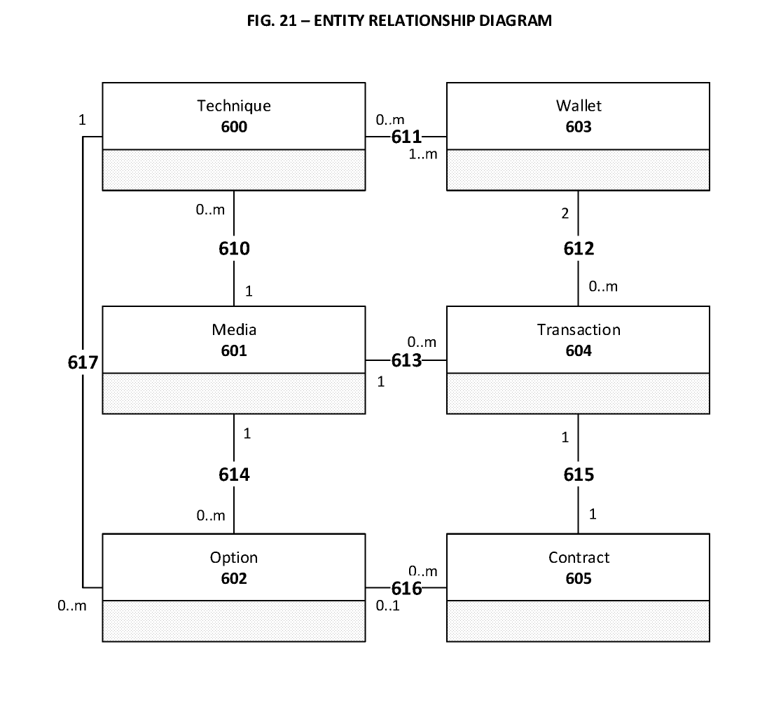

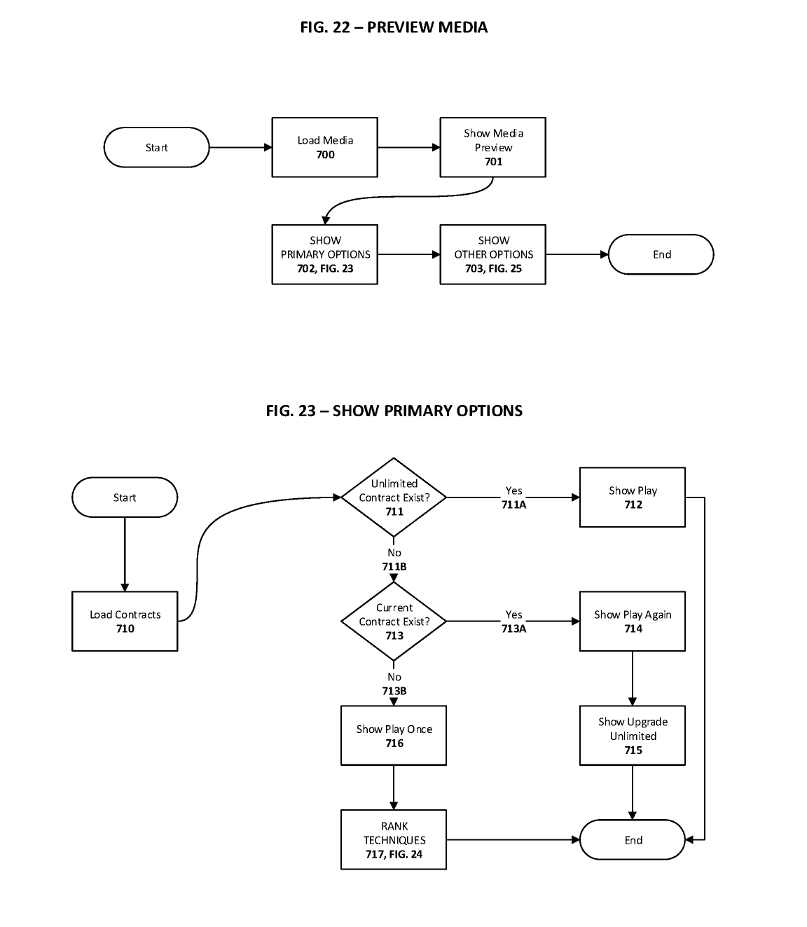

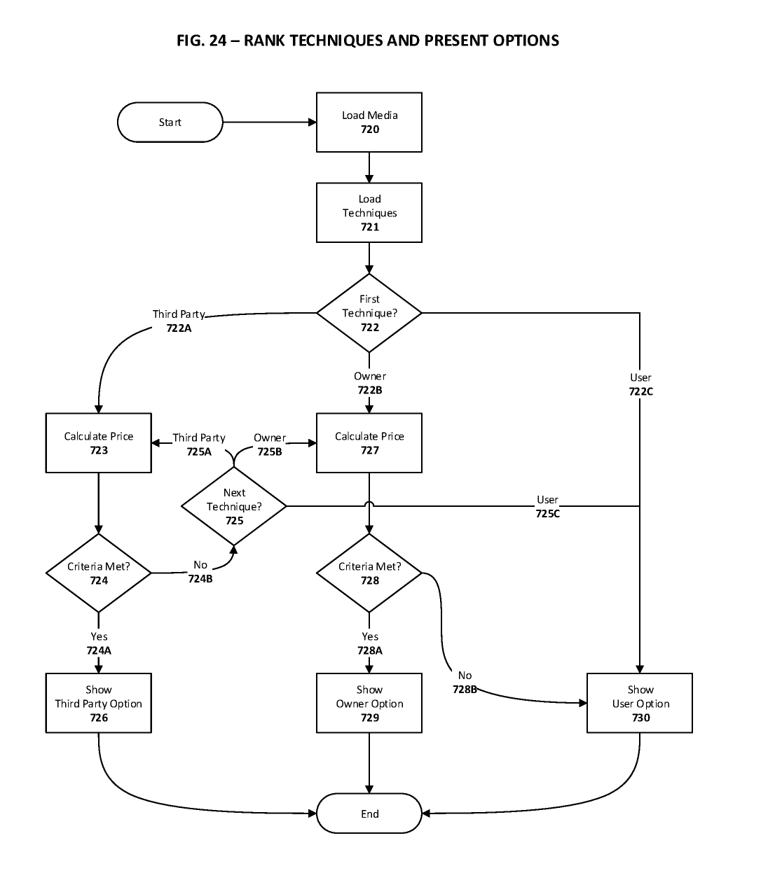

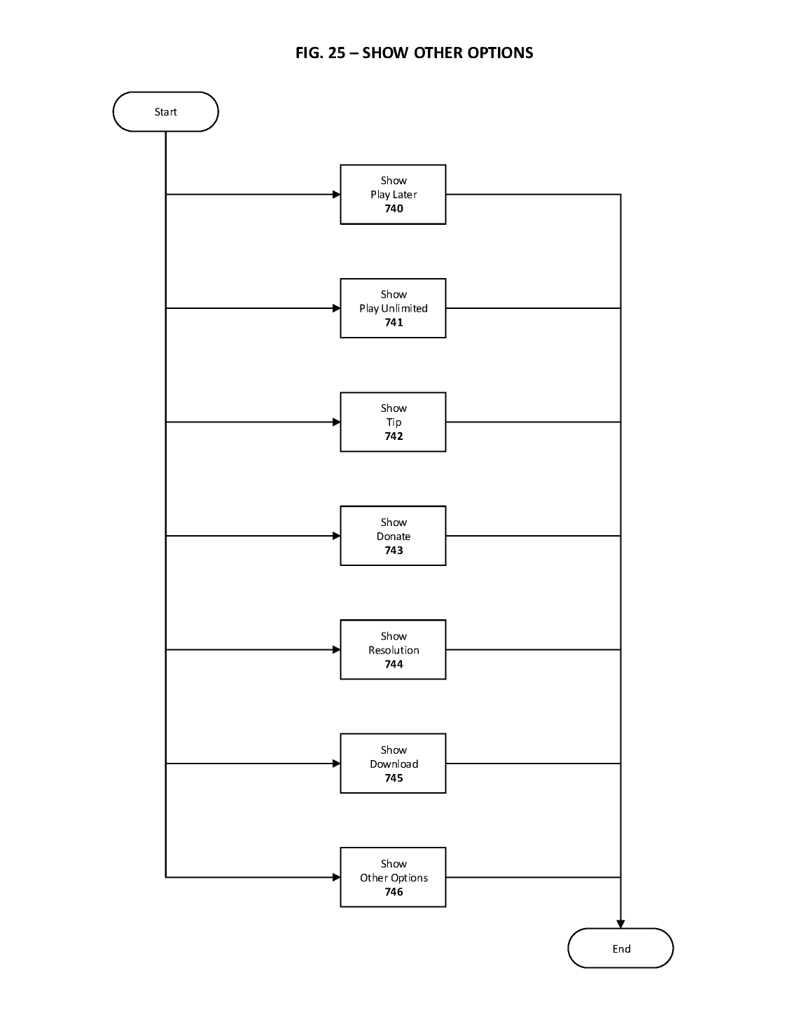

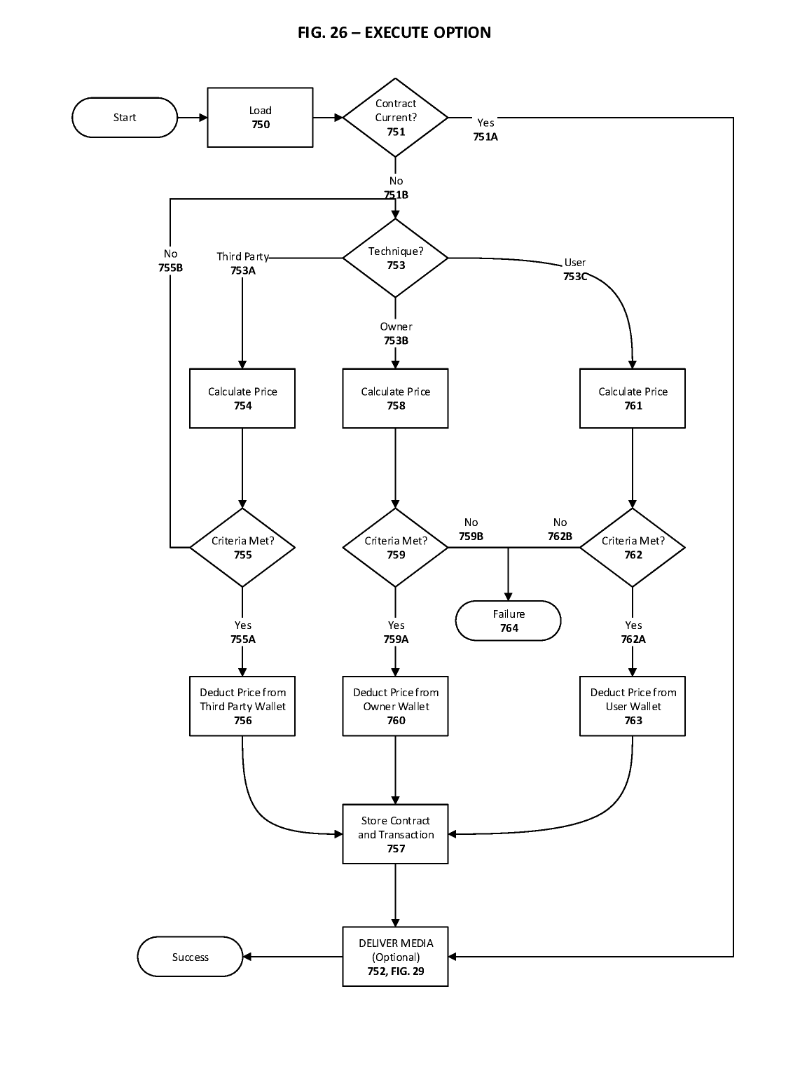

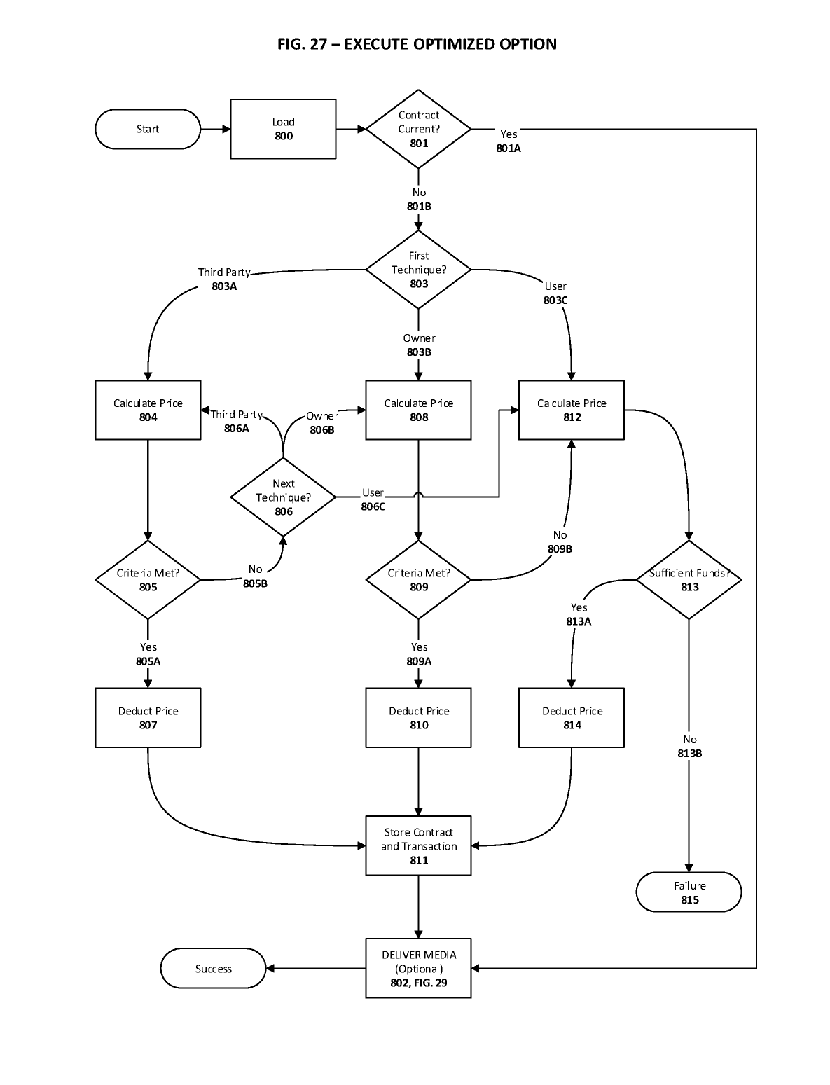

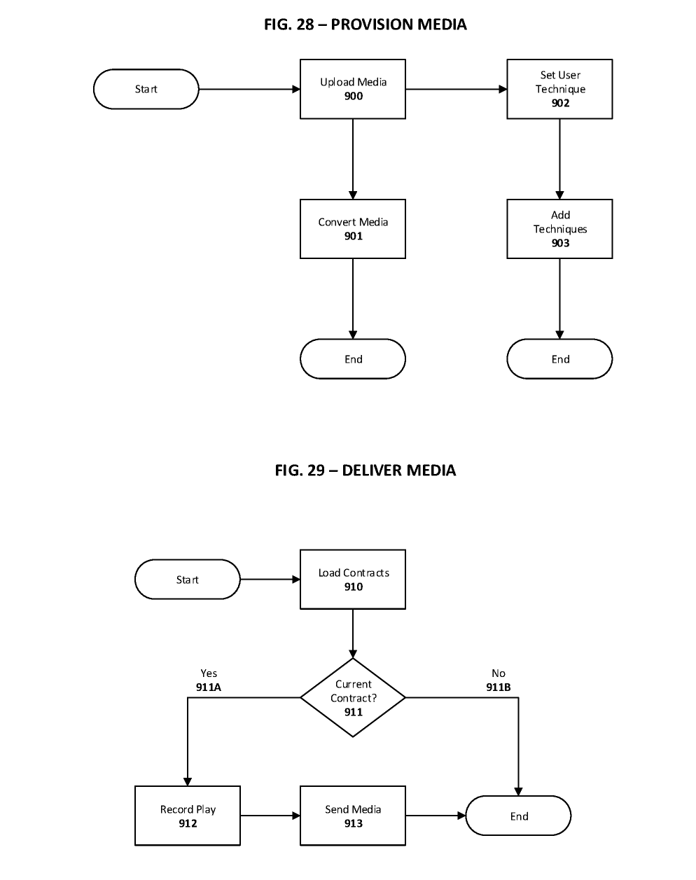

In the embodiment as illustrated in FIG. 21, FIG. 22, FIG. 23, FIG. 24, FIG. 25, FIG. 26, FIG. 27, FIG. 28, and FIG. 29, the present invention has been adapted for use as an online media (e.g., music, movies, TV, books, articles, etc.) marketplace. Several specific terms are used to illustrate the use of this specific application (e.g., an Option is labeled “Play Once” or “Play Unlimited”); these are illustrative and may be changed to meet the needs of the implementer (e.g., “Play Once” may be renamed “Stream”; in the context of text media, “Play Once” may be changed to “Read” or “View Article”). The types or names of the Options, or the specific manner of presentation of Options (e.g., Options are located at the top of the page instead of under the media player, or Options are presented as a drop-down menu rather than as buttons), may be changed to meet the needs of the implementer and do not change the nature of the present invention.

Database of Media, Techniques, and Transactions

FIG. 21 illustrates a database entity relationships diagram for automatically switching Techniques.

A Wallet 603 record may represent a User Wallet, Owner Wallet, Intermediary Wallet, and/or Third Party Wallet. Each Wallet comprises fields that represent a Balance and a Currency for that Balance (e.g. $10 USD, where 10 is the balance and USD is the currency). Each Wallet 603 record is stored in a database table of Wallet 603 records. Value may be added to a Wallet 603 record from a financial transaction such as transfer from a credit card, bank account, check, or any other method of payment. This payment may occur manually at the request of the Wallet owner or automatically when certain criteria are met (e.g., a transaction reducing the balance to a set minimum balance triggers a top-up transaction). Additionally, Value may be added to the Wallet as a result of a transfer or payment from another Participant.

A Media 601 record includes fields for media description information, media content (including but not limited to audio, video, image, and/or text), any version of the media content necessary for a specific delivery method, and default pricing information.

A Technique 600 record may include, but is not limited to, fields for a Technique, a payment Technique classification (e.g., User-Paid, Owner-Paid, or Third-Party-Paid), contract requirements, contract rights, contract restrictions, availability (e.g., from and to dates), references to each Wallet that will be used as the source of payment (e.g., one or more Wallets where a single Technique may have many payers, such as in an ad-supported Technique), and pricing information for a specific media item represented by a Media 601 record. The Technique 600 record may also include a priority and other fields to enable the System to evaluate and rank the Technique record.

A Transaction 604 record includes fields for date, time, transaction amount, currency, exactly one Media 601 record reference, exactly two Wallet 603 record references, and one Contract 605 record reference. A Buyer Wallet 603 record reference represents the Buyer in a transaction, where the Buyer may be any Wallet owner. A Seller Wallet 603 record reference represents the Seller in a transaction, where the Seller may be any Wallet owner.

A Contract 605 record includes fields for contract rights, terms, and restrictions as well as a reference to an associated Transaction 604 record. Contract 605 information may be included within a Transaction 604 record or stored separately, as represented in 605.

Each Media 601 record, Technique 600 record, Wallet 603 record, Transaction 604 record, and Contract 605 record is stored in a corresponding database table and links and/or references are created between those database records.

An Option 602 record includes fields for price, and other display purposes, plus references to the Media 601 record, Technique 600 record, and Contract 605 record being presented. The Option 602 record may be stored in a database, and/or kept in computer memory until the User selects an Option or the Option record expires, and/or stored in some other temporary medium until the Option 602 record is no longer needed (e.g., the User has moved to a different media item or the session has expired).

Each Media 601 record is associated with zero or more Technique 600 records, and each Technique 600 record is associated with one Media 601 record 610. Where a Media 601 record is associated with zero Technique 600 records, a default record is created in processor memory using any Technique. However, a marketplace Technique is recommended as the default.

Each Technique 600 record is associated with one or more Wallet 603 records, and each Wallet 603 record is associated zero or more Technique 600 records 611.

Each Wallet 603 record is associated with zero or more Transaction 604 records, and each Transaction 604 record is associated with exactly two Wallet 603 records 612.

Each Media 601 record is associated with zero or more Transaction 604 records, and each Transaction 604 record is associated with exactly one Media 601 record 613.

Each Media 601 record is associated with zero or more Option 602 records, and each Option 602 record is associated with exactly one Media 601 record 614.

Each Transaction 604 record is associated with one Contract 605 record, and each Contract 605 record is associated with one Transaction 604 record 615.

Each Option 602 record is associated with zero or more Contract 605 records, and each Contract 605 record is associated with zero or one Option 602 records 616.

Each Option 602 record is associated with one Technique 600 record, and each Technique 600 record is associated with zero or more Option 602 records 617.

Preview Media

FIG. 22 illustrates a computerized method for displaying a Media Preview and calls other computerized methods for displaying Primary Option 602 records to a User 702 & FIG. 23 and a computerized method for displaying Other Option 602 records to a User 703 & FIG. 25.

The processor loads 700 a Media 601 record into computer memory.

The processor generates 701 a Media Preview from the Media 601 record fields and sends the Media Preview to the User as illustrated in FIG. 3 110. The Media Preview may include, but is not limited to, summaries, thumbnails, samples, or other truncated or limited versions of the Media.

The processor generates 702 & FIG. 23 a set of Primary Option 602 records that are sent to the User.

The processor generates 703 & FIG. 25 a set of Other Option 602 records that are sent to the

User.

As illustrated in FIGS. 3 111 & 112, the invention shows a number of Primary Option 602 records that are a subset of all possible Options 602 records, to simplify the choice presented to the User. All Other Option 602 records are considered valid, but those Other Option 602 records are placed in the Other Options section FIG. 7 152, which is accessed via the menu FIG. 3 114 & FIG. 7 153 and allows the User to expand the choices available if the Primary Options do not meet the User's requirements. The User Wallet balance is provided FIG. 3 115 to help the User make an informed choice.

The terms Primary Option and Other Option are separated to simplify the description of this embodiment and may be referred to collectively as Options. Primary Options and Other Options are interchangeable; the distinction is primarily one of presentation, as Primary Options are presented to the User more prominently, while Other Options are presented less prominently (e.g., through a collapsed menu). There may be any number of Primary Options, and any number of Other Options (including zero); however, it is recommended that the implementer provide between one and three Primary Options, with the remainder of Options being treated as Other Options. A User chooses from the Options that are presented with the Primary Options acting as a short list and the Other Options acting as a complete list. It is not essential to display all Options. Selecting an Option causes a processor to execute a computerized method associated with that Option. Each Option may have a name, price, Technique, and other terms associated with it.

Show Primary Options

FIG. 23 illustrates a computerized method for automatically switching Techniques when displaying Options.

The processor loads 710 all existing Contract 605 records for the current User and the specific Media 601 record into computer memory.

The processor tests 711 each loaded Contract 605 record against the rights and restrictions within the Contract 605 record to determine whether or not the Contract 605 record may be considered current. A Contract 605 record is considered current if it meets the conditions of Contract rights and restrictions and can be used at that time for the specific Media 601 record. Examples of tests to determine whether a Contract 605 record is current include, but are not limited to, whether the terms of the Contract have expired, whether a specified number of uses of the Media has been exceeded, and whether the Media itself is still available or has expired.

The processor tests 711 each Contract 605 record to determine if an Unlimited Use Contract with the User exists.

If an Unlimited Use Contract with the User exists 711A, the processor delivers 712 Play Option to the User as illustrated in FIG. 7 150.

If an Unlimited Use Contract with the User does not exist 711B, the processor tests 713 each other Contract 605 record for any other condition that would allow any of the Contract 605 records to be determined to be current.

If any other Contract 605 record is determined to be current 713A, the processor sends 714 a Primary Option (e.g., “Play Again”) to the User as illustrated in FIG. 9 170 and another Primary Option (e.g., “Upgrade to Unlimited”) is sent 715 to the User as illustrated in FIG. 6 140 & FIG. 9 171.

If no Contract 605 record is determined to be current 713B, a first Primary Option (e.g., “Play Once”) is sent 716 to the User as illustrated in FIG. 3 111, and a second Primary Option (e.g., “Play Unlimited” or “Play Ad-Supported”) FIG. 3 112 is determined 717 by calling the SORT TECHNIQUES computerized method as illustrated in FIG. 24. It is recommended that two Primary Options be sent to a User, but any number of Primary Options may be delivered to suit the needs of the implementer (including the use of a static third Primary Option, e.g., the first and second Primary Options are determined by this method but a third static Primary Option of “Donate” is always included based on the preference of the Owner and/or System).

Rank Techniques

FIG. 24 illustrates a computerized method for presenting ranked Techniques when displaying Primary Options to a User.

The processor loads 720 a specified Media 601 record into computer memory.

The processor loads 721 all Technique 600 records that are referenced by the loaded Media 601 record into computer memory.

The processor determines 722 the first Technique 600 record according to its priority and other fields.

If the Technique is Third-Party-Paid 722A, the processor loads the referenced Third Party Wallet 603 record into computer memory, and calculates 723 a price based on the price contained in the Technique 600 record less any price previously paid as determined by a review of other current Contract 605 records for the same Media 601 record by the same User (e.g., the User previously purchased a single use and is now purchasing an upgrade—the difference between the previous purchase price and the current purchase price is calculated).

The processor tests 724 the Technique criteria to determine whether the Third Party Technique 600 record should be used (e.g., a User-defined category may be used to match a Technique 600 record and automatically limit choice, or the duration of the Media may limit applicable Techniques), and compares 724 the balance of the Third Party Wallet 603 record to the price calculated in 723, to determine whether the Third Party has sufficient funds to pay for the purchase.

If the Third Party Technique criteria are met, and the balance of the Third Party Wallet 603 record has sufficient funds 724A, the processor sends 726 a Primary Option (e.g., “Play Free”) to the User as illustrated in FIG. 4 120 & FIG. 5 130. The Primary Option may display information about the Technique (e.g., ad-supported, ad duration, sponsored), Contract, price, and type of support (e.g., trailer, commercial ad, donation request). The Option 602 record stores references to the Technique 600 record and Contract 605 record for use by the System when the User chooses this Option.

If the Third Party Technique criteria are not met, or the balance of the Third Party Wallet 603 record is insufficient 724B, the System tests 725 the next Technique 600 record. If another Third Party Technique 604 record is found 725A that Third Party Wallet 603 record is loaded into computer memory 723 and the process may repeat until no further Third Party Technique 600 records exist.

If the Technique is Owner-Paid 722B or 725B, the processor loads the Owner Wallet 603 record is loaded into computer memory and calculates 727 a price based on the price contained in the Technique 600 record less any price previously paid as determined by a review of other current Contract 605 records for the same Media 601 record by the same User (e.g., the User previously purchased a single use and is now purchasing an upgrade—the difference between the previous purchase price and the current purchase price is calculated).

The Technique criteria are tested to determine if the Owner Technique 600 record should be used (e.g., a User-defined category may be used to match a Technique 600 record and automatically limit choice, or the duration of the Media may limit applicable Techniques), and the processor compares 728 the balance of the Owner Wallet 603 record to the price as calculated in 727 to determine whether the Owner has sufficient funds to pay for the purchase.

If the Owner Technique criteria are met, and the balance of the Owner Wallet 603 record has sufficient funds 728A, the processor sends 729 a Primary Option (e.g., “Play Free”) to the User as illustrated in FIG. 10 180. The Primary Option may display information about the Technique (e.g., number of free plays remaining, expiry of free play), Contract, price, and type of support (e.g., “Creator Supported”). The Option 602 record stores references to the Technique 600 record and Contract 605 record for use by the System when the User chooses this Option.

If the Owner Technique criteria are not met, or the balance of the Owner Wallet 603 record is insufficient 728B, or the Technique is User-Paid 722C or 725C, the processor sends 730 a Primary Option (e.g., “Play Unlimited”) to the User as illustrated in FIG. 3 112. The Primary Option may include information about the Technique, Contract, price, and type of support. The Option 602 record stores references to the Media 601 record, Technique 600 record, and Contract 605 record for use by the System when the User chooses this Option.

The Options presented here are illustrated as “Play Once” and “Play Unlimited,” but any Option may be used (or presented differently). For example, the Play Once Option or Play Unlimited Option may be replaced with a Play X Option FIG. 8 160 (e.g., “Play 10 Times”). In this case, the Contract further restricts the permission (e.g., number of plays, expiry). The Option 602 record stores references to the Technique 600 record and Contract 605 record for use by the System when the User chooses this Option.

If no further Techniques exist, the Technique is assumed to be User-Paid and the User Technique is used for the last iteration 725 & 725C.

It is possible to use multiple Techniques for the same Option and to perform partial tests in 724 or 728. For example, a Third-Party-Paid Technique, an Owner-Paid Technique, and a User-Paid Technique may be used in conjunction in an Option, with each offering partial support (e.g., Third Party contributes 1 cent, Owner contributes 1 cent, and User contributes 1 cent to acquire a User contract). In another example, multiple Third Parties may offer support (e.g., Play Free with two 15-second ads and two 30-second ads for a 40-minute video Media, with each ad selected from different Third Parties).

In another embodiment, the method may be reduced by treating each Technique as a Third-Party-Paid Technique. Each Technique would evaluate criteria and the party paying, as has been demonstrated with Owner Technique and Owner-Paid, and User Technique and User-Paid.

In another embodiment, it is possible to create default Technique 600 records and Contract 605 records for all Media 601 records that an Owner has provided to simplify the Owner's management activities.

In another embodiment, it is possible to provide a User profile (i.e., Preferences) that also limits the automatic nature of Technique selection 722 & 725. For example, a User may prefer never to see ad-supported Techniques below a certain price, or, when a certain price is exceeded, the User may wish to make an offer below the requested price.

Show Other Options

FIG. 25 illustrates a computerized method for displaying other User Options. Each Option may be displayed in parallel (as illustrated) or sequentially. The order is not important.

The Options illustrated in FIG. 25 are optional, and represent a group of Options that may be commonly desirable for illustrative purposes; the set of Option 602 records may be expanded, shortened, eliminated, or otherwise modified to suit the needs of the implementer. The naming, presentation, and characteristics of Options may be modified to suit the needs of the implementer.

A Play Later Option is optionally displayed 740 as illustrated in FIG. 7 152 and offers the User the ability to purchase Media immediately for later consumption. The Option may display information about the Technique (e.g., number of free plays remaining, expiry of free play), Contract, price, and type of support. The Option 602 record stores references to the Technique 600 record and Contract 605 record for use by the System when the User chooses this Option.

A Play Unlimited Option is optionally displayed 741 as illustrated in FIG. 3 112 and offers the User the ability to purchase an unlimited use Contract. Alternatively, other Play Options may be displayed here offering different Techniques and Contracts. Each Option may display information about the Technique (e.g., number of free plays remaining, expiry of free play), Contract, price, and type of support. Each Option 602 record stores references to the Technique 600 record and Contract 605 record for use by the System when the User chooses this Option.

A Tip Option is optionally displayed 742 as illustrated in FIG. 7 151 and offers the User the ability to offer a gratuity to the Owner of the Media. It is possible to customize the name of the Tip Option (e.g., rename “Tip” to “That was Awesome”) and to offer any Value the User chooses. The Tip Option may also entitle the User to additional Media Contracts that are provided only when a Tip is offered, in which case, the Option 602 record stores references to the Media 601 records, Technique 600 records, and Contract 605 records for use by the System when the User chooses this Option.

A Donate Option is optionally displayed 743 (not illustrated but may be used as a replacement of Tip FIG. 7 151) and offers the User the ability to donate to the Owner of the Media or to an entity nominated by the Owner. It is possible to customize the name of the Donate Option (e.g., rename “Donate” to “Feed a Lion”) and offer any Value the User chooses. The Donate Option may also entitle the User to additional Media Contracts that are provided only when a Donation is offered, in which case, the Option 602 record stores references to the Media 601 records, Technique 600 records, and Contract 605 records for use by the System when the User chooses this Option.

A Resolution Option is optionally displayed 744 (not illustrated but may be used in other Options FIG. 7. 152 or within the Media player FIG. 3 110 which is a customary placement for changing resolution) and offers the User the ability to change the quality of the Media to be delivered (e.g., high definition, standard definition). Each Resolution may define different prices used to modify the calculated price of any Media item.

A Download Option is optionally displayed 745 (not illustrated but may be used in other options FIG. 7 152) and offers the User the ability to download the Media for offline use. The Download Option may be treated in an identical manner to a Play Unlimited Option or an Upgrade Unlimited Option as it usually will provide the User with a similar Contract to Unlimited Use Options.

Other Options may be displayed 746 as illustrated in FIG. 7 152 that give the User the ability to choose from multiple Options. In each case, the Option stores references to the Media records, Technique records, and Contract records.

One or more Other Option(s) may be included with the Primary Options as illustrated in FIG. 3 113. The Other Option may be defined and stored based on User Preferences, or may be selected based on the ranking process described for Primary Options, or may be otherwise selected by the Owner or the System itself.

Execute Option

FIG. 26 illustrates a computerized method for executing an Option.

When the User chooses an Option, the processor extracts from the Option 602 record references to the Media 601 record, Technique 600 record, and Contract 605 record. Each of these references is used to load 750 the Media 601 record, Technique 600 record, and existing User Contract 605 records from the database into computer memory. Although a single Technique 600 record may be present in the Option 602 record, multiple Technique 600 records may be loaded as multiple Technique 600 records may be associated with a single Media 601 record. This way, the actual Technique 600 record sent may vary from what was originally proposed.

The processor loads 750 the selected Media 601 record from the database into computer memory, and loads 750 all existing Contract 605 records that reference the current User and the specific Media 601 record into computer memory.

The processor tests 751 each loaded Contract 605 record to determine whether a current Contract 605 record exists. Examples of tests to determine whether a Contract 605 record is current include, but are not limited to, whether the terms of the Contract have expired, whether a specified number of uses of the Media has been exceeded, and whether the Media itself is still available or has expired.

If a Contract is determined to be current 751A, the processor sends 752 the Media to the User as illustrated in FIG. 29.

If no existing Contract is determined to be current 751B, the processor loads 753 all Technique 600 records that reference the Media 601 record into computer memory. The processor determines 753 the first Technique 600 record by its priority and other fields.

If the Technique 600 record is Third-Party-Paid 753A, the processor loads 754 the Third Party Wallet 603 record into computer memory. The processor calculates 754 a price based on the price contained in the Technique 600 record less any price previously paid as determined by a review of other current Contract 605 records for the same Media 601 record by the same User 754 (e.g., the User previously purchased a single use and is now purchasing an upgrade—the difference between the previous purchase price and the current purchase price is calculated).

The Technique criteria are tested to determine if the Third Party Technique should be used (e.g., a User defined category may be used to match a Technique and automatically limit choice, or the duration of the Media may affect chosen Techniques), and the balance of the Third Party Wallet FIG. 21 603 record is compared against the price as calculated in 754 to determine if the Third Party has sufficient funds to pay for the purchase 755.

If the Third Party Technique criteria are met, and the balance of the Third Party Wallet 603 record has sufficient funds 755A, the price calculated in 754 is deducted from the Third Party Wallet 603 record and updated to the database 756. Transaction 604 and Contract 605 records are created that contain the price, references to the Media 601 record and Contract 605 record that are then saved to the database 757. The Media is sent to the User 752 as illustrated in FIG. 29.

If the Third Party Technique criteria are not met, or the balance of the Third Party Wallet 603 record is insufficient 755B, the system tests 753 the next Technique 600 record. If another Third Party 753A. Technique 600 record is found, that Third Party Wallet 603 record is loaded 754 and the process may repeat until no further Technique 600 records exist. The System may automatically replenish the balance of a Third Party Wallet 603 record at the time it is tested (e.g., a low balance triggers an automatic payment to the Wallet), thereby changing the initial outcome of the test.

If the Technique 600 record is Owner-Paid 753B, the Owner Wallet 603 record is loaded into computer memory and a price is calculated 758 based on the price contained in the Technique 600 record less any price paid as determined by a review of other current contracts for the same media by the same user (e.g., the user purchased a single-use contract and is purchasing an upgrade—the difference between contracts may be calculated). The actual calculation performed may vary depending on the Technique and previous purchase history.

The Technique criteria are tested to determine if the Owner Technique should be used (e.g., an Owner defined category may be used to match a Technique 600 record and automatically limit choice, or the duration of the Media may affect chosen Techniques), and balance of the Owner Wallet FIG. 21 603 record is compared 759 against the price as calculated in 758 to determine if the Owner has sufficient funds to pay for the purchase.

If the Owner Technique criteria are met, and the balance of the Owner Wallet 603 record has sufficient funds 759A, the price calculated in 758 is deducted from the Owner Wallet 603 record and updated to the database 760. Transaction 604 and Contract 605 records are created that contain the price, references to the Media 601 record and Contract 605 record that are then saved to the database 757. The Media is sent to the User 752 as illustrated in FIG. 29.

If the Owner Technique criteria are not met, or the balance of the Owner Wallet 603 record is insufficient 759B the method ends to prevent any unexpected changes to the Technique 600 record and the User is notified of the failure 764. The System may automatically replenish the balance of an Owner Wallet 603 record at the time it is tested (e.g., a low balance triggers an automatic payment to the Wallet 603 record), thereby changing the initial outcome of the test.

If the Technique 600 record is User-Paid 753C, the User Wallet 603 record is loaded into computer memory and a price is calculated 761 based on the price contained in the Technique 600 record less any price paid as determined by a review of other current Contract 605 records for the same Media 601 record by the same user (e.g., the user purchased a single contract and is purchasing an upgrade—the difference between contracts may be calculated). The actual calculation performed may vary depending on the Technique and previous purchase history.

The Technique criteria are tested to determine if the User Technique should be used (e.g., a User defined category may be used to match a Technique 600 record and automatically limit choice, or the duration of the Media may affect chosen Techniques), and balance of the User Wallet 603 record is compared against the price as calculated in 761 to determine if the User has sufficient funds to pay for the purchase 762.

If the User Technique criteria are met, and the balance of the User Wallet has sufficient funds 762A, the price calculated in 761 is deducted from the User Wallet and updated to the database 763. Transaction and Contract records are created that contain the price, references to the User and Media and Contract, that are then saved to the database 757. The Media is delivered 752 to the User as illustrated in FIG. 29.

If the User Technique criteria are not met, or the balance of the User Wallet 603 record is insufficient 762B the method ends and the User is notified of the failure 764. The System may automatically replenish the balance of a User Wallet 603 record at the time it is tested (e.g., a low balance triggers an automatic payment to the Wallet 603 record), thereby changing the initial outcome of the test.

It is possible to use the steps in the selection of the Technique FIG. 24 to perform a double verification and ensure that the Technique criteria are still met. Those tests would be performed immediately before or after any test of any Wallet 603 record 755, 759, and 762.

Execute Optimized Option

FIG. 27 illustrates a computerized method for executing an Optimized Option

The EXECUTE OPTIMIZED OPTION computerized method is executed as an automatic strategy, in which the User chooses to consume the Product (e.g., such as by selecting “Play” on a video Product) and the System automatically selects and executes an Option on behalf of the User. The System may select the Option 602 record according to any number of factors, including information received by the User (e.g., the User has set a preference to never see ads; the User prefers to see ads when the paid price exceeds $0.50) or any information available in any way to the System (e.g., the particular User's purchasing history, the satisfaction of other consumers who have purchased the specific Product, or the prices of similar Products at that point in time).

The selected Media 601 record is loaded from the database into computer memory 800 and all existing Contract 605 records for the specific Media 601 record are loaded into computer memory 800.

Each Contract 605 record is tested to determine if a current Contract 605 record exists 801. Examples of tests for currency include, but are not limited to, whether the terms of the contract have not expired, a specified number of uses of the media has not been exceeded, and the media itself is no longer available or has expired.

If a Contract 605 record is determined to be current 801A, the Media record is sent to the User 802 as illustrated in FIG. 29.

If no Contract 605 record is determined to be current 801B, all Technique 600 records associated with the Media 601 record are loaded into computer memory and the first Technique 600 record is determined by its priority and other fields 803.

If the Technique 600 record is Third-Party-Paid 803A, the Third Party Wallet 603 record is loaded into computer memory and a price is calculated based on the price contained in the Technique 600 record less any price paid as determined by a review of other current Contract 605 records for the same Media 601 record by the same User 804 (e.g., the User purchased a single contract and is purchasing an upgrade—the difference between contracts may be calculated). The actual calculation performed may vary depending on the Technique and previous purchase history.

The balance of the Third Party Wallet 603 record is compared against the price as calculated in 804 to determine if the Third Party has sufficient funds to pay for the purchase 805.

If the Third Party Technique 600 record should be used (e.g., a User defined category may be used to match a Technique and automatically limit choice, or the duration of the Media may affect chosen Techniques) and the balance of the Third Party Wallet 603 record has sufficient funds 805A, then the price calculated in 804 is deducted from the Third Party Wallet 603 record and updated to the database 807. Transaction 604 and Contract 605 records are created that contain the price, references to the Media 601 record and Contract 605 record, and are then saved to the database 811. The Media is sent to the User 802 as illustrated in FIG. 29.

If the Third Party Method criteria are not met, and the balance of the Third Party Wallet 603 record is insufficient 805B, the Switching System tests the next Technique 600 record 806. If another Third Party 806A. Technique 600 record is found, that Third Party Wallet 603 record is loaded 804 and the process may repeat until no further Technique 600 records exist.

If the Technique 600 record is Owner-Paid 803B & 806B, the Owner Wallet 603 record is loaded into computer memory and a price is calculated based on the price contained in the Technique 600 record less any price paid as determined by a review of other current Contract 605 records for the same Media 601 record by the same User 808 (e.g., the User purchased a single contract and is purchasing an upgrade—the price difference between contracts may be calculated). The actual calculation performed may vary depending on the Technique and previous purchase history.

The balance of the Owner Wallet 603 record is compared against the price as calculated in 808 to determine if the Owner has sufficient funds to pay for the purchase 809.

If the Owner Technique criteria are met, and the balance of the Owner Wallet 603 record has sufficient funds 809A, the price calculated in 808 is deducted from the Owner Wallet 603 record and updated to the database 810. Transaction 604 and Contract 605 records are created that contain the price, references to the Media 601 record and Contract 605 record, that are then saved to the database 811. The Media is sent to the User 802 as illustrated in FIG. 29.

If the Owner Technique criteria are not met, or the balance of the Owner Wallet 603 record is insufficient 809B or the Technique 600 record is User-Paid 803C or 806C, the User Wallet 603 record is loaded into computer memory and a price is calculated based on the price contained in the Technique 600 record less any price paid as determined by a review of other current Contract 605 records for the same Media 601 record by the same User 812 (e.g., the User purchased a single contract and is purchasing an upgrade—the price difference between contracts may be calculated). The actual calculation performed may vary depending on the Technique and previous purchase history.

The balance of the User Wallet 603 record is compared against the price as calculated in 812 to determine if the User has sufficient funds to pay for the purchase 813.

If the balance of the User Wallet 603 record has sufficient funds 813A, the price calculated in 812 is deducted from the User Wallet 603 record and updated to the database 814. Transaction 604 and Contract 605 records are created that contain the price, references to the Media 601 record and Contract 605 record, and are then saved to the database 811. The Media is sent to the User 802 as illustrated in FIG. 29.

If the balance of the User Wallet 603 record is insufficient 813B the method ends and the User is notified of the failure 815.

If no further Technique 600 records exist, the Technique 600 record is assumed to be User-Paid (e.g., marketplace) and is used for the last iteration 803 & 806.

Prvision Media

FIG. 28 illustrates a computerized method for provisioning media and assigning a set of Technique 600 records to a Media 601 record.

The Owner uploads a media file and it is stored as metadata in a Media 601 record in the database 900.

The Media file is converted to a range of media formats and stored in the database for later delivery to Users 901.

The Owner sets prices and terms for the default User-Paid Technique, and the Media 601 and Technique 600 record are updated with the provided information and stored in the database 902.

The Owner optionally adds one or more Third Party or Owner-Paid Techniques and each Technique 600 record is updated with the provided information and stored in the database 903.

In another embodiment, Media and Techniques may be assigned in a batch process to simplify management. Default Media and Techniques fields may also be used when a new record is created.

Deliver Media

FIG. 29 illustrates a computerized method for delivering media.

The Media Contract 605 records for the selected Media 601 record are loaded into computer memory 910 and tested to determine if the Contract 605 record is current 911. If no current Contract 605 record is found 911B, the computerized method ends.

If a current Contract 605 record is found 911A, the access to the media may be recorded for statistical purposes 912, the Media is sent to the User in their preferred format 913, and the computerized method ends.

Other Embodiments

Although the present invention has been described in terms of various embodiments, it is not intended that the invention be limited to these embodiments. Modification within the spirit of the invention will be apparent to those skilled in the art.

For example, the Switching System can be adapted for use at a retail outlet to replace manual negotiations and permit business methods that are not presently technically or financially feasible. The Switching System could also be optimized for a specific set of business methods thereby simplifying embodiments described.

It is conceivable that the System in the present invention may be subdivided into other Subsystems (e.g., such as splitting Account, Wallet, and Transaction components into a Subsystem, and Technique and Option components into a Subsystem, and Contract component into a Subsystem). The design of the Subsystems is intended to be flexible, and any such Subsystems should be considered embodiments of this invention. The use of this invention as a Subsystem in another System is expected, but such inclusion is not necessary in order to implement the present invention, nor will such inclusion change the nature of the present invention.

In another embodiment, the sorting method of the present invention may be implemented with static sequence that is universal to all Sellers. Similarly, any sorting performed for Buyers may also be made static by one of ordinary skill in the art.

Although this invention describes automatic switching of Techniques in an electronic commerce system, it is possible to use these methods for switching Techniques when providing any Product in any commerce system and/or market.

We claim:

1. A computer-implemented method comprising:
receiving a request for at least one option record;
identifying and retrieving first set of technique records for said request;
extrapolating first set of technique records into first set of option records;
eliminating unsuitable option records from first set of option records;
sending first set of option records to the requestor.

2. The method according to claim 1, wherein said extrapolating step, utilizes a one-to-one transformation of technique records to option records.

3. The method according to claim 1, wherein said extrapolating step, utilizes a one-to-many transformation of technique records to option records.

4. The method according to claim 1, further comprising:
receiving a requested option;
identifying and retrieving second set of technique records for said requested option;
extrapolating second set of technique records into second set of option records;
eliminating unsuitable option records from second set of option records;
verifying requested option record exists in second set of option records to produce a verified option record;
creating at least one contract records and at least one transaction records that reference verified option record;
executing the technique associated with said verified option record.

5. The method according to claim 4, wherein said requested option, is automatically selected from first set of option records.

6. A non-transitory computer-readable medium including one or more sequences of instructions which, when executed by one or more processors, cause:
receiving a request for at least one option record;
identifying and retrieving first set of technique records for said request;
extrapolating first set of technique records into first set of option records;
eliminating unsuitable option records from first set of option records;
sending first set of option records to the requestor.

7. The non-transitory computer-readable medium of claim 6, wherein said extrapolating step, utilizes a one-to-one transformation of technique records to option records.

8. The non-transitory computer-readable medium of claim 6, wherein said extrapolating step, utilizes a one-to-many transformation of technique records to option records.

9. The non-transitory computer-readable medium of claim 6, further comprising:
receiving a requested option;
identifying and retrieving second set of technique records for said requested option;
extrapolating second set of technique records into second set of option records;
eliminating unsuitable option records from second set of option records;
verifying requested option record exists in second set of option records to produce a verified option record;
creating at least one contract records and at least one transaction records that reference verified option record;
executing the technique associated with said verified option record.

10. The non-transitory computer-readable medium of claim 9, wherein said requested option, is automatically selected from first set of option records.

11. A system comprising:
one or more processors; and
a non-transitory computer-readable medium including one or more sequences of instructions which, when executed by one or more processors, cause:
receiving a request for at least one option record;
identifying and retrieving first set of technique records for said request;
extrapolating first set of technique records into first set of option records;
eliminating unsuitable option records from first set of option records;
sending first set of option records to the requestor.

12. The system according to claim 11, wherein said extrapolating step, utilizes a one-to-one transformation of technique records to option records.

13. The system according to claim 11, wherein said extrapolating step, utilizes a one-to-many transformation of technique records to option records.

14. The system according to claim 11, further comprising:
receiving a requested option;
identifying and retrieving second set of technique records for said requested option;
extrapolating second set of technique records into second set of option records;
eliminating unsuitable option records from second set of option records;
verifying requested option record exists in second set of option records to produce a verified option record;
creating at least one contract records and at least one transaction records that reference verified option record;
executing the technique associated with said verified option record.

15. The system according to claim 14, wherein said requested option, is automatically selected from first set of option records.
